(19) United States
(12) Patent Application Publication
(10) Pub. No.: US 2013/0230927 A1
(43) Pub. Date: Sep. 5, 2013

(54) URINARY PORPHYRINS AS BIOMARKERS OF AUTISTIC SPECTRUM DISORDER RISK

(71) Applicants: James Woods, Seattle, WA (US); Diana Echeverria, Seattle, WA (US); Nicholas J. Heyer, Seattle, WA (US)

(72) Inventors: James Woods, Seattle, WA (US); Diana Echeverria, Seattle, WA (US); Nicholas J. Heyer, Seattle, WA (US)

(73) Assignees: BATTELLE MEMORIAL INSTITUTE, Richland, WA (US); UNIVERSITY OF WASHINGTON THROUGH ITS CENTER FOR COMMERCIALIZATION, Seattle, WA (US)

(21) Appl. No.: 13/884,513

(22) PCT Filed: Nov. 9, 2011
(86) PCT No.: PCT/US11/60044

§ 371 Date: May 9, 2013

Related U.S. Application Data
(60) Provisional application No. 61/411,915, filed on Nov. 9, 2010.

(51) Int. Cl. G01N 21/64

(52) U.S. Cl. CPC G01N 21/6486
USPC 436/81

(57) ABSTRACT

In one aspect, the present invention provides a method of screening a human subject for the presence of or risk of developing, an autistic spectrum disorder (ASD) comprising determining the amount of at least one porphyrin from a set of porphyrin biomarkers for ASD in a biological sample obtained from the subject.

### CROSS-REFERENCE TO RELATED APPLICATION

This application claims the benefit of Provisional Application No. 61/411,915, filed Nov. 9, 2010, the disclosure of which is hereby incorporated herein by reference in its entirety.

### STATEMENT OF GOVERNMENT LICENSE RIGHTS

This invention was made with government support under P30ES007033, awarded by National Institutes of Health (NIH)—Federal Reporting. The government has certain rights in the invention.

### FIELD OF THE INVENTION

Aspects of the disclosure are generally directed to using excreted porphyrins as biomarkers for determining the presence or risk of developing autistic spectrum disorder in a human subject.

### BACKGROUND

Autism (AUT) (OMIM 209850) is a complex neurodevelopmental disorder that, along with Asperger Syndrome and Pervasive Developmental Disorders Not Otherwise Specified (PDD-NOS), comprises the expanded classification of autistic spectrum disorder (ASD). Autism (AUT), or autistic spectrum disorder (ASD), afflicts as many of one in 110 children in the United States (Rice, C., “Prevalence of Autistic Spectrum Disorders—Autism and Developmental Disabilities Monitoring Network, United States,” MMRW Morbidity and Mortality Weekly Report 58(SS10):1-20, 2009). The rising rate of diagnosis of ASD may be associated with heightened awareness, increased incidence or other factors (Fombonne, E., Epidemiology of Pervasive Developmental Disorders,” Pediatric Research 65:591-598, 2009; Ratajczak, H. V., “Theoretical Aspects of Autism: Causes—A Review,” Journal of Immunotoxicology 8:68-79, 2011). What is clear is that early detection leads to improved efficacy of treatment and a better quality of life for many ASD patients. This concern has spurred the search for early biological markers of ASD. Although genetic factors are likely to play a principal role in the etiology of autism, only 10-15% of validated cases have known genetic causes, and fewer than 3% of cases are associated with any specific genetic factor (Levy, S. E., et al., “Autism,” The Lancet 374:1627-1638). Thus, several non-genetic biological measures have been offered as biomarkers of ASD. A small study of placental tissue specimens from 13 ASD cases and 61 controls found abnormalities in 38.5% of cases and 13.1% of controls (Anderson, G. M., et al., “Placental Trophoblast Inclusions in Autism Spectrum Disorder,” Biological Psychiatry 61:487-491, 2007), suggesting the potential utility of trophoblastic anomaly assessments in the early detection of ASD. In addition, the utility of functional MRI in detecting autism has been recently reported (Perkins, T., et al., “Mirror Neuron Dysfunction in Autism Spectrum Disorders,” Journal of Clinical Neuroscience 17:1239-1243, 2010).

Despite these observations, relatively few biological markers of autism or ASD risk have been identified and brought into clinical use for early diagnosis. Therefore, a need exists for a reliable biomarker for autism and other aspects of ASD that is simple to apply clinically to facilitate early intervention treatment.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present invention provides a method of screening a human subject for the presence of, or risk of developing, an autistic spectrum disorder (ASD). The method comprises (a) determining the amount of at least one porphyrin from a set of porphyrin biomarkers for ASD in a biological sample obtained from the subject; (b) comparing the amount of the at least one porphyrin determined in step (a) to a reference standard or threshold value; and (c) determining the presence or risk of developing an autistic spectrum disorder in the subject, wherein an elevated amount of the at least one porphyrin compared to the reference standard or threshold value is indicative of the presence of or increased risk of developing an autistic spectrum disorder in the subject. In some embodiments, the set of porphyrin biomarkers for ASD comprises 4-carboxyl porphyrin, 5-carboxyl porphyrin, 6-carboxyl porphyrin, and 7-carboxyl porphyrin.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIG. 1 schematically illustrates the heme biosynthetic pathway, wherein the principal components of the heme biosynthetic pathway are illustrated in the left hand column, and the corresponding constituents excreted into the urine are illustrated in the right hand column, as described in EXAMPLES 1-3;

FIGS. 2A-F illustrate distributions of urinary uroporphyrin (A), heptacarboxyl porphyrin (B), hexacarboxyl porphyrin (C), pentacarboxyl porphyrin (D), precoproporphyrin (E), and coproporphyrin (F), respectively, by age. Each bar represents the mean individual creatinine-adjusted urinary porphyrin level (nmol/g) by age group for nonchelated NT (n=57) and AUT (n=59) boys, covering ages 2-12 years. 95% confidence intervals (CI) are indicated on each bar. An asterisk (*) indicates a significant difference between the NT and same-age AUT group (p≦0.05), as described in EXAMPLE 1;

FIGS. 3A-F illustrate scatterplots and linear regression models showing the association between urinary uroporphyrin (A), heptacarboxyl porphyrin (B), hexacarboxyl porphyrin (C), pentacarboxyl porphyrin (D), precoproporphyrin (E), and coproporphyrin (F), respectively, and age. Scatterplots and simple linear regression fit lines of natural logs are illustrated for the individual creatinine-adjusted urinary porphyrin levels by age group for nonchelated NT (n=57) and AUT (n=59) boys, age 2-12 years, as described in EXAMPLE 1;

FIG. 4 graphically illustrates the distribution of pentacarboxyl porphyrin and coproporphyrin concentrations by age with regression-predicted levels and 95% CI for controls. FIG. 4A graphically illustrates the distribution of urinary pentacarboxyl porphyrin concentrations by age among AUT, PDD-NOS and NT subjects. FIG. 4B graphically illustrates the distribution of urinary coproporphyrin concentration by age among AUT, PDD-NOS and NT subjects. Solid lines in FIGS. 4A and B represent regression of the porphyrin concentrations with age and associated 95% CI for controls, and show that the highest concentrations of either porphyrin are associated with AUT and PDD-NOS cases, as described in EXAMPLE 3;

FIG. 5 graphically illustrates the distribution of Z-scores for porphyrin biomarkers. FIG. 5A graphically illustrates the distribution of the combined Z-scores for pentacarboxyl porphyrin and coproporphyrin by age among AUT, PDD-NOS and NT subjects. FIG. 5B shows the individual Z-scores for pentacarboxyl porphyrin and coproporphyrin plotted against each other and their regression slope and 95% CI after eliminating 10 ‘outlier’ cases, as described in EXAMPLE 3; and

FIG. 6 graphically illustrates ROC curves for three porphyrin measures predicting autism and PDD-NOS. Individual lines depict the proportion of AUT (FIG. 6A) or of PDD-NOS (FIG. 6B) identified by each porphyrin predictor as true positives (Sensitivity) in relation to the proportion identified as false positives (1-Specificity) from among all 76 study subjects (30 AUT+14 PDD-NPS+32 NT), as described in EXAMPLE 3.

### DETAILED DESCRIPTION

The following description provides specific details for a thorough understanding of, and enabling description for, embodiments of the disclosure. However, one skilled in the art will understand that the disclosure may be practiced without these details. In other instances, well-known structures and functions have not been shown or described in detail to avoid unnecessarily obscuring the description of the embodiments of the disclosure. Therefore, unless defined otherwise, all technical and scientific terms used herein have the meaning commonly understood by one of ordinary skill in the art to which this invention belongs.

The following definitions are presented to provide clarity with respect to the terms as they are used in the specification and claims and to describe the present invention.

As used herein, the term “autistic spectrum disorder” and the abbreviation “ASD” are used interchangeably, and are used to describe an array of related developmental disorders. Individual disorders that are included in ASD are Autism (AUT), Asperger's Syndrome and Pervasive Developmental Disorder Not Otherwise Specified (PDD-NOS). These disorders share some common features, and are typically characterized by social deficits, communication deficits, stereotyped or repetitive behaviors and interests, and cognitive deficits and/or delays. Each named disorder has a unique profile of characteristics including severity, and are thus thought to be distinct disorders on a spectrum. Criteria for the various disorders comprising ASD are described, for example, in the Diagnostic and Statistical Manual of Mental Disorders, Fourth Edition, Text Revision (DSM-IV-TR) American Psychiatric Association, incorporated herein by reference, (as corrected in text revision).

As used herein, the term “autism” and the abbreviation “AUT” are used interchangeably, and refer to a developmental disorder within ASD. AUT is generally characterized by delays or abnormal functioning before the age of 3 in one or more of the following domains: (1) social interaction, (2) communication, and (3) restricted, repetitive and stereotyped patterns of behavior, interests and activities. Specific criteria for AUT are described, for example, in the Diagnostic and Statistical Manual of Mental Disorders, Fourth Edition (DSM-IV-TR), American Psychiatric Association.

As used herein, the term “Pervasive Developmental Disorder Not Otherwise Specified” and the abbreviation “PDD-NOS” are used interchangeably and refer to a disorder within ASD. PDD-NOS is generally considered to be subthreshold autistic disorder because it is often characterized by only a single AUT criterion or domain. Furthermore, subjects with PDD-NOS do not meet the standard criteria for other pervasive developmental and psychological disorders, such as schizophrenia. Specific criteria for PDD-NOS are described, for example, in the Diagnostic and Statistical Manual of Mental Disorders, Fourth Edition, Text Revision (DSM-IV-TR), American Psychiatric Association.

As used herein, the term “porphyrin” refers to a class of organic molecules that are in relevant biological systems and are formed as precursor intermediates in the biosynthesis of heme, which is also a porphyrin. The biosynthesis of heme occurs in most eukaryotic tissues. As explained in more detail below, in humans and other mammals, porphyrins with 8-, 7-, 6-, 5-, and 4-carboxyl groups are commonly formed in excess for heme synthesis, and thus are often excreted and are detectable in the urine. 8-carboxyl porphyrin is also designated herein as uroporphyrin. 7-carboxyl porphyrin is also designated herein as heptacarboxyl porphyrin. 6-carboxyl porphyrin is also designated herein as hexacarboxyl porphyrin. 5-carboxyl porphyrin is also designated herein as pentacarboxyl porphyrin. 4-carboxyl porphyrin is also designated herein as coproporphyrin.

Unless the context clearly requires otherwise, throughout the description and the claims, the words ‘comprise’, ‘comprising’, and the like are to be construed in an inclusive sense as opposed to an exclusive or exhaustive sense; that is in the sense of “including, but not limited to.” Words using the singular or plural number also include the plural or singular number, respectively. Additionally, the words “herein,” “above,” and “below,” and words of similar import, when used in this application, shall refer to this application as a whole and not to any particular portions of this application.

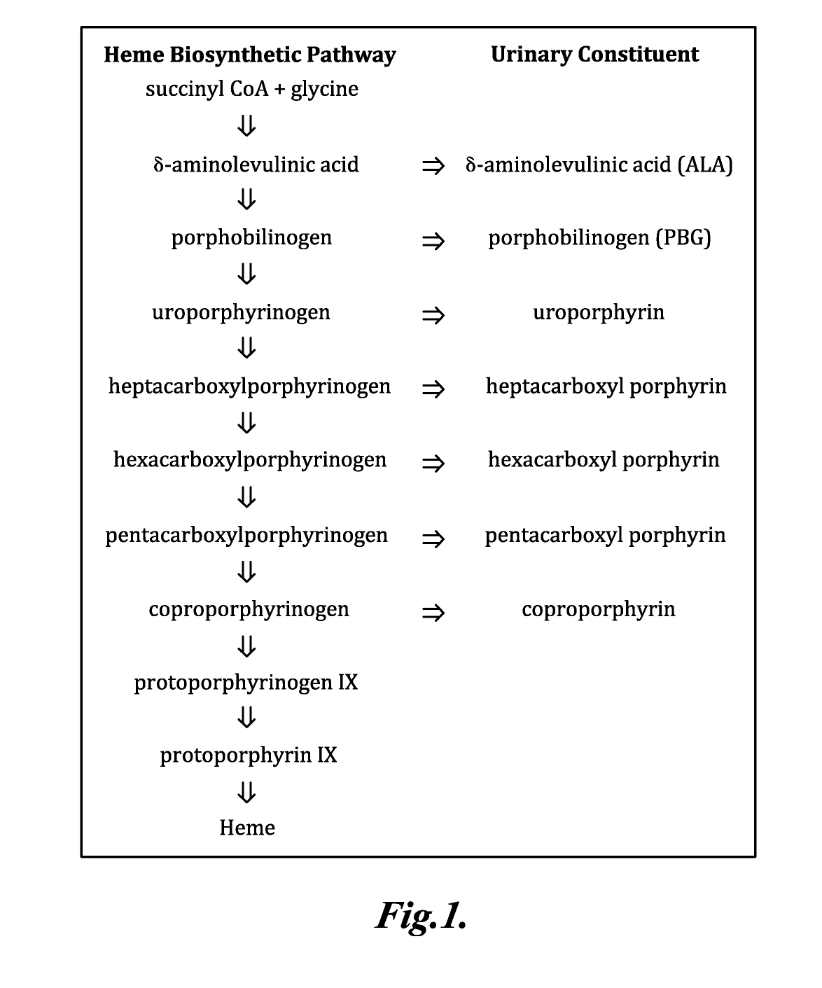

Porphyrins are formed as intermediates in the biosynthesis of heme, a process that proceeds in essentially all eukaryotic tissues (FIG. 1). In humans and other mammals, porphyrins with 8-, 7-, 6-, 5- and 4-carboxyl groups are commonly formed in excess of that required for heme biosynthesis and are excreted in the urine in well-established patterns and concentration ranges (Ford, R. E., et al., “Liquid-Chromatographic Analysis for Urinary Porphyrins,” Clinical Chemistry, 27:397-401, 1981; Bowers, M. A., et al., “Quantitative Determination of Porphyrins in Rat and Human Urine and Evaluation of Urinary Porphyrin Profiles During Mercury and Lead Exposures,” Journal of Laboratory and Clinical Medicine 120:272-281, 1992; Woods, J. S., et al., “Urinary Porphyrin Profiles as a Biomarker of Mercury Exposure: Studies on Dentists With Occupational Exposure to Mercury Vapor,” Journal of Toxicology and Environmental Health 40:235-246, 1993; Woods, J. S., “Porphyrin metabolism as indicator of metal exposure and toxicity,” Handbook of Experimental Pharmacology: Toxicology of Metals-Biochemical Aspects, Berlin: Springer Verlag, Goyer, R. A. and Cherian, M., (Eds.), 115:19-52, 1995; Woods, J. S., et al., “Urinary Porphyrin Excretion in Normal Children and Adolescents,” Clinica Chimica Acta 405:104-109, 2009b).

Changes in the urinary concentrations of specific porphyrins have been observed in association with mercury, lead and other toxicant exposures and have been proposed as biomarkers of such exposures in humans (Marks, G. S., “Exposure to Toxic Agents: The Heme Biosynthetic Pathway and Hemoproteins as Indicator,” Critical Review in Toxicology 15:151-179, 1985; Bowers et al., 1992; Woods, 1995). Several reports (Kern, J. K., el al., “Sulfhydryl-Reactive. Metals in Autism,” Journal of Toxicology and Environmental Health 70:715-721, 2007; Mutter, J. et al., “Mercury and Autism: Accelerating Evidence?” Neuroendocrinology Letters 26:439-446, 2005; Windham, G. C., et al., “Autism Spectrum Disorders in Relation to Distribution of Hazardous Air Pollutants in the San Francisco Bay Area, Environmental Health Perspectives 114:1.438-1444, 2006) have implicated prenatal and/or postnatal Hg exposure as associated with autism, in terms of frequency of exposure as well as total body burden. Notably, important mechanistic and toxicokinetic distinctions between different forms of Hg (Burbacher T. M., et al., “Comparison of Blood and Brain Mercury Levels in Infant Monkeys Exposed to Methylmercury or Vaccines Containing Thimerosal,” Environmental Health Perspectives 113:1015-1021, 2005) or in child-specific factors (Faustman, E. M., “Mechanisms Underlying Children's Susceptibility to Environmental Toxicants,” Environmental Health Perspectives 108(suppl 1):13-21, 2000) that might affect susceptibility to Hg in autism remain to be fully considered in studies of this association. There have been several of reports of aberrant porphyrin excretion among children with ASD from Korea (Youn, S. I., et al., “Porphyrinuria in Korean Children With Autism: Correlation With Oxidative Stress,” Journal of Toxicology and Environmental Health 73:701-710, 2010), Australia (Austin, D. W., and Shandley, K., “An Investigation Porphyrinuria in Australian Children With Autism,” Journal of Toxicology and Environmental Health 71:1349-1351, 2008), France (Nataf, R., “Porphyrinuria in Childhood Autistic Disorder: Implications for Environmental Toxicity,” Toxicology and Applied Pharmacology 214:99-108, 2006), and the United States (Geier, D. A., et al., “A Prospective Blinded Evaluation of Urinary Porphyrins Verses the Clinical Severity of Autism Spectrum Disorders,” Journal of Toxicology and Environmental Health 72:1585-1591, 2009; Kern, J. K., et al., “Toxicity Biomarkers in Autism Spectrum Disorder: A Blinded Study on Urinary Porphyrins,” Pediatrics International 53:147-153, 2011). In these cases, these findings are associated with, or attributed to, mercury or other toxicant exposures, and/or the oxidative stress associated therewith.

The present invention was developed in the course of an exploratory study to address several issues associated with the use of urinary porphyrin changes as a diagnostic biomarker of Hg exposure among children and, in particular, those with autism. For example, urinary porphyrin concentrations were measured and compared for neurotypical (NT) children between 2 and 12 years and same-age autistic children. The porphyrin levels were assessed to determine whether differences in urinary porphyrin levels existed between NT and autistic children of the same age and, if so, if they were consistent with recent Hg exposure as assessed by urinary Hg levels and/or past Hg exposure. The present inventors made the surprising discovery that several porphyrins detected in the urine of the subjects were indicators of autism independent of any heavy metal exposure, and thus had utility as direct biomarkers for autism or ASD.

In accordance with the foregoing, in one aspect, the invention provides a method of screening a human subject for the presence of, or risk of developing, an autistic spectrum disorder (ASD). The method comprises (a) determining the amount of at least one porphyrin from a set of porphyrin biomarkers for ASD in a biological sample obtained from the subject; (b) comparing the amount of the at least one porphyrin determined in step (a) to a reference standard or threshold value; and (c) determining the presence or risk of developing an autistic spectrum disorder in the subject, wherein an elevated amount of the at least one porphyrin compared to the reference standard or threshold value is indicative of the presence of or increased risk of developing an autistic spectrum disorder in the subject.

In some embodiments, the set of porphyrin biomarkers for ASD comprises 4-carboxyl porphyrin, 5-carboxyl porphyrin, 6-carboxyl porphyrin, and 7-carboxyl porphyrin.

In accordance with one embodiment of the invention, as exemplified in EXAMPLE 1, the inventors made several comparisons of urinary porphyrin concentrations among autistic children aged 2-12 years (n=59) with those of age- and gender-matched neurotypical (NT) controls (n=57) and found significant (p<0.05) logistic odds ratios for 6-carboxyl porphyrin (also designated “hexacarboxyl porphyrin”) (OR=1.65[1.07=2.55]), 5-carboxyl porphyrin (also designated “pentacarboxyl porphyrin”) (OR=2.36[1.37-4.071), and 4-carboxyl porphyrin (also designated “coproporphyrin”) (OR=2.03[1.15-3.571) for AUT verses NT. Furthermore, the urinary concentration of 7-carboxyl porphyrin (also designated “heptacarboxyl porphyrin”) (OR=1.83[0.93-3.581) was moderately associated with AUT versus NT. In contrast, the concentration of 8-carboxyl porphyrin (uroporphyrin) (OR=1.06[0.58-1.961) is generally comparable between AUT and NT. These findings suggested that 6-, 5-, 4-carboxyl and 7-porphyrins, alone or collectively, may be strong predictors of autism risk, each having a significant association with this diagnosis independent of heavy metal exposure. These observations of disordered porphyrin metabolism are of particular interest in relation to underlying etiology of autism in light of the critical role played by heme in neurological development and the impact of impaired heme synthesis on this process (Chernova, T., et al., “Heme Deficiency Is Associated With Senescence and Causes Suppression of N-methyl-D-aspartate Receptor Subunits Expression in Primary Cortical Neurons,” Molecular Pharmacology 69:697-705; Sengupta, A., et al., “Heme Deficiency Suppresses the Expression of Key Neuronal Genes and Causes Neuronal Cell Death,” Molecular Brain Research 137:23-30, 2005).

As further described in EXAMPLE 2, the specificity and sensitivity of various urinary porphyrins 4-, 5-, and 6-carboxyl as biomarkers of autism were assessed using Receiver Operator Characteristic (ROC) curve analysis. Specifically, amounts of urinary porphyrins 4-, 5-, and 6-carboxyl porphyrins were assessed, with and without normalization with 8-carboxyl porphyrin levels in the urine. Additionally, combinations of the porphyrins were tested as biomarkers. The results show that these porphyrin measurements serve as sensitive biomarkers that are capable of discriminating NT subjects from subjects with AUT.

As further described in EXAMPLE 3, the observations of EXAMPLES 1 and 2 were extended by specifically evaluating 5- and 4-carboxyl porphyrins as biomarkers of

ASD among 76 male children comprising 30 with validated AUT, 14 with PDD-NOS and 32 neurotypical (NT) controls. ASD children (AUT and PDD-NOS) had higher mean urinary 5-carboxyl porphyrin (p<0.006) and 4-carboxyl porphyrin (p<0.006) concentrations compared to same-aged NT children, each characterized by a number of extreme values. Using ROC curve analysis, the sensitivity and specificity of 5-carboxyl porphyrin, 4-carboxyl porphyrin, and their combined Z-scores were evaluated in ASD detection. The 5-carboxyl porphyrin sensitivity was 30% for AUT and 36% for PDD-NOS, with 94% specificity. The 4-carboxyl porphyrin sensitivity was 33% and 14%, respectively, with 94% specificity. The combined Z-score measure had 33% and 21% sensitivity for AUT and PDD-NOS, respectively, with 100% specificity. These findings demonstrate that the porphyrin measures are strong predictors of both AUT and PDD-NOS and establish the clinical utility of urinary porphyrin measures for identifying a subgroup of ASD subjects in whom disordered porphyrin metabolism may be a salient characteristic.

In accordance with the foregoing, in one aspect, the present invention provides a method of screening for the presence of, or risk of developing, an autistic spectrum disorder (ASD) in a human subject. The method comprises determining the amount of at least one porphyrin from a set of porphyrin biomarkers for ASD in a biological sample obtained from the subject. The amount of the at least one porphyrin is compared to a reference standard or threshold value. The presence or risk of developing an autistic spectrum disorder in the subject is determined, wherein an elevated amount of the at least one porphyrin compared to the reference standard or threshold value is indicative of the presence or risk of developing of an autistic spectrum disorder in the subject.

In some embodiments, the invention provides a method for screening for the presence of an autistic spectrum disorder in a human subject. In some embodiments, the method is a screen for the presence of any one of the ASD disorders, including Autism (AUT), Asperger's Syndrome, and/or Pervasive Developmental Disorder Not Otherwise Specified (PDD-NOS). In some embodiments, the method is used as an initial biomarker screening for the presence of any one of the ASD disorders in the subject that can be verified by performance of additional behavioral tests and/or diagnostic techniques that are currently known in the art. For example, as described in EXAMPLE 1, the ASD/AUT status of individuals in a population of test subjects was assessed by a multidisciplinary approach that combines using the criteria described in the Diagnostic and Statistical Manual of Mental Disorders, Fourth Edition, Text Revision (DSM-IV-TR) along with psychological evaluation using the Autism Diagnostic Observation Schedule (ADOS). In some embodiments, the method is used as a screen for the presence of autism in the subject. In some embodiments, the method is used as a screen for the presence of PDD-NOS.

In some embodiments, the invention provides a method for screening for the risk of developing an autistic spectrum disorder in a human subject. In some embodiments, the method is a screen for the risk of developing any one of the ASD disorders, including Autism (AUT), Asperger's Syndrome, and/or Pervasive Developmental Disorder Not Otherwise Specified (PDD-NOS). In some embodiments, the method is a screen for the risk level for developing one of the disorders described above within 1, 2, 3, 4, 5, 6, 7, 8, 9, or 10 years from the date of performing the screen. The phrase “development of a disorder” encompasses situations where a concurrent test for the disorder would not necessarily indicate presence of the disorder, but an additional test performed at a time in the future does indicate the presence or increased risk of developing the disorder. This situation may arise because the subject possesses the underlying foundation for the disorder, but the symptoms have not yet manifested in the subject's observable behavior. In some embodiments, the method provides a screen for the risk of developing autism in the subject. In some embodiments, the method provides a screen for PDD-NOS in the subject.

In some embodiments, the set of porphyrin biomarkers for ASD comprises one or more (i.e. at least one, at least two, at least three, or at least four) of 4-carboxyl porphyrin, 5-carboxyl porphyrin, 6-carboxyl porphyrin, and 7-carboxyl porphyrin.

In some embodiments, the method comprises determining the amount of at least one porphyrin selected from the above set of porphyrin biomarkers in the biological sample. In some embodiments, the method comprises determining the amount of 2, 3, or all 4 of the porphyrin biomarkers selected from the above set of porphyrin biomarkers in the biological sample. In one embodiment, the method comprises determining the amount of 4-carboxyl porphyrin in the biological sample. In one embodiment, the method comprises determining the amount of 5-carboxyl porphyrin in the biological sample. In yet another embodiment, the method comprises determining the amount of 4-carboxyl porphyrin and 5-carboxyl porphyrin in the biological sample.

The amount of the at least one porphyrin in the biological sample can be determined by the performance of any suitable assay that can discriminate and quantify the specific target porphyrin from a biological sample. Such assays can utilize detectable labels that specifically bind to the target porphyrin, such as an immunoassay. An example of a suitable immunoassay is an ELISA utilizing a labeled antibody, or fragment thereof, which can be detected and quantified. In another embodiment, the target porphyrin(s) can be detected using chromatographic methods. For example, in the embodiments described in EXAMPLES 1 and 3, the target porphyrins were detected using a high-performance liquid chromatography (HPLC)—spectrofluorometric assay, as described previously (see, e.g., Bowers, M. A., et al., “Quantitative Determination of Porphyrins in Rat and Human Urine and Evaluation of Urinary Porphyrin Profiles During Mercury and Lead Exposures,” Journal of Laboratory and Clinical Medicine 120:272-281, 1992, incorporated herein by reference in its entirety).

In some embodiments, the assay is performed to determine the concentration of the at least one porphyrin in the biological sample. Concentration can be expressed as the abundance of the porphyrin divided by the volume of the biological sample.

In other embodiments, the amount of the at least one porphyrin is normalized by a quantifiable characteristic of the biological sample that is not associated with ASD presence or risk. For example, the concentration of the at least one porphyrin can be expressed as the abundance of the porphyrin divided by the other characteristic of the biological sample. For example, in some embodiments, the step of determining the amount of the at least one porphyrin comprises performing an assay to determine its concentration in the sample, which concentration value is then divided by the concentration of creatinine in the biological sample. Considering that both the numerator and denominator of this value is a concentration, the value can be expressed equivalently as the abundance or amount of the at least one porphyrin in the sample divided by the abundance or amount of creatinine in the same sample, without reference to the volume of the specific sample. Accordingly, in some embodiments, the concentration of the at least one porphyrin is normalized for concentration creatinine in the biological sample. Stated otherwise, the amount of the at least one porphyrin in the biological sample is normalized for the amount of creatinine in the biological sample.

As demonstrated and described in EXAMPLES 1 and 2, individuals exhibit wide variations of urinary porphyrin levels. However, much of the variation is determined by the level of 8-carboxyl porphyrin (also designated uroporphyrin). Considering that 8-carboxyl porphyrin was demonstrated to not be associated with ASD presence or risk, that porphyrin can be used to reduce the porphyrin variation among test subjects. Accordingly, in some embodiments, determining the amount of the at least one porphyrin from a set of porphyrin biomarkers further comprises performing an assay to determine the amount or concentration of 8-carboxyl porphyrin in the sample. The amount or concentration of the target, i.e., biomarker, porphyrin can be normalized by dividing the value with the corresponding value for 8-carboxyl porphyrin from the same biological sample.

It will be apparent to persons of ordinary skill in the art that the amount or concentration of the at least one porphyrin in the biological sample can be normalized to one or multiple other quantifiable characteristics of the biological sample. To illustrate, the amount or concentration of the at least one porphyrin can be normalized by both the amount of creatinine and 8-carboxyl porphyrin in the biological sample.

A person of ordinary skill in the art will recognize that any conversion of the data, such as a logarithmic conversion, can be performed as necessary to facilitate computational or statistical comparisons of data. Accordingly, in some embodiments of the method, the step of determining the amount of the at least one porphyrin in the biological sample further comprises calculating a logarithmic value to facilitate further analysis of multiple values. For example, in some embodiments, the natural logarithm of the amount or concentration is generated. In other embodiments, the common or base ten logarithm of the amount or concentration is generated.

A person of ordinary skill in the art will recognize that the data conversion, such as a logarithmic conversion, can be performed with or without prior normalization steps or other data manipulations. To illustrate in the context of using natural log conversions of the porphyrin levels, the amounts or concentrations of two or more porphyrins in the biological sample are determined and the sum of the levels are converted to a natural logarithm value. For example, the concentrations of 4-carboxyl porphyrin, 5-carboxyl porphyrin, and 6-carboxyl porphyrin in the biological sample are determined and the sum is converted to a natural logarithm value. In other embodiments, the amount or concentration of the at least one porphyrin biomarker in the biological sample is normalized before a natural logarithm value is determined. To illustrate, in one embodiment, the concentrations of 4-carboxyl porphyrin, 5-carboxyl porphyrin, and 6-carboxyl porphyrin in the biological sample are determined, a sum value is generated, and the sum value is divided by the concentration of 8-carboxyl porphyrin in the biological sample to generate a ratio of the combined porphyrin biomarker concentrations to the concentration of 8-carboxyl porphyrin in the biological sample. The ratio represents normalization for the abundance of 8-carboxyl porphyrin in the sample. This ratio can be converted to a natural logarithmic value. Additional representative embodiments of this type of conversion are described below in EXAMPLE 2.

The method also comprises comparing the determined amount of the at least one porphyrin to a reference standard or threshold value. It will be understood by persons of skill in the art that comparison to a reference or threshold value is most informative when the reference standard or threshold value is determined using the similar techniques as were used to obtain the value for the at least one porphyrin in the biological sample obtained from the subject. Therefore, in some embodiments of the method, the reference standard or threshold value reflect values for the same at least one porphyrin selected from the set of porphyrin biomarkers. In some embodiments, the reference standard or threshold value reflects values that have been converted and/or normalized in a similar manner as was used to convert the value in reflecting.

In some embodiments, the reference standard or threshold value is obtained from one or more control human subjects that are neurotypical (NT). In some embodiments, the neurotypical control subject(s) is/are known to be negative for any of the disorders that are identified as being part of the ASD spectrum, such as Autism (AUT), Asperger's Syndrome, and Pervasive Developmental Disorder Not Otherwise Specified (PDD-NOS). In some embodiments, the neurotypical control subject(s) is/are known to be negative for any identifiable developmental delay or deficit.

In some embodiments, the reference standard or threshold value is obtained from one control human subject that is neurotypical (NT). In some embodiments, the reference standard or threshold value is obtained from a plurality of control human subjects that are neurotypical (NT). In some embodiments, the reference standard or threshold value is obtained from a population of control human subjects that are neurotypical (NT). For example, the reference standard or threshold value is obtained from about 2 to about 10, from about 10 to about 20, from about 20 to about 30, from about 30 to about 40, from about 40 to about 50, from about 50 to about 60, from about 60 to about 70, from about 70 to about 80, from about 80 to about 90, from about 90 to about 100 or more subjects that are neurotypical (NT).

In some embodiments, the control subject(s) is/are of an equivalent age of the human (test) subject. The phrase “an equivalent age” is used to convey that, at the time the biological sample(s) was/were obtained from the control subject(s) to determine the reference standard or threshold value, the control subject(s) was/were of an age that is similar to the age of the human (test) subject at the time the biological sample was obtained from the human (test) subject. In some embodiments, at the time the biological sample(s) was/were obtained, the control subject's age or subjects' ages was/were within at least 6 months to 3 year(s) from the age of the human (test) subject's age (such as from at least 6 months to at least 2 years, or at least 6 months to 1 year) at the time the biological sample was obtained from the human (test) subject. For example, in some embodiments, at the time the biological sample(s) was/were obtained the control subject(s) was/were of an age that is within 2 years (older or younger) of the age of the human (test) subject at the time the biological sample was obtained from the human (test) subject.

In some embodiments of the method, the human (test) subject is a child or adolescent at the time the biological sample is obtained. For example, the human (test) subject of an age from newborn to about 15 years old at the time the biological sample is obtained. Therefore, in some embodiments, the human (test) subject is of an age of about 1, 2, 3, 4, 5, 6, 7, 8, 9, 10, 11, 12, 13, 14, or 15 years old, or within any range therein, at the time the biological sample is obtained. For example, in some embodiments, the human (test) subject is of an age of about 2 to about 12 years old at the time the biological sample is obtained. In other embodiments, the human (test) subject is of an age of about 2 to about 5 years old at the time the biological sample is obtained.

In some embodiments of the method, the biological sample obtained from the human (test) subject is a bodily fluid or bodily excretion comprising excreted porphyrin(s). In some embodiments, the biological sample can be any one of urine, blood, serum, plasma, or feces. For example, in the embodiments described in EXAMPLES 1-3, the biological sample was urine collected during the first or second void of the day.

In some embodiments, the concentration of at least one porphyrin in the biological sample has already been measured and is readily available. Thus, in some embodiments, rather than performing an assay to measure the concentration of the at least one porphyrin, the data is acquired from a source, such as a database, or over the Internet or by other electronic means.

In accordance with various embodiments of the invention, the method encompasses determining the presence of, or risk of developing, an ASD in the test subject based on the comparison of the amount of the at least one porphyrin from the set of porphyrin biomarkers for ASD determined in the biological sample to the reference standard or threshold value. Upon comparison, an elevated amount of the at least one porphyrin compared to the reference standard or threshold value is indicative of the presence of, or increased risk of developing, an autistic spectrum disorder (ASD) in the subject.

Any appropriate statistical approach known by those of skill in the art may be used to determine the presence or absence of a statistically relevant elevation in one or more porphyrin levels, in accordance with various embodiments of the invention.

In some embodiments, a determination of an elevated amount of at least one porphyrin is reflective of an absolute difference between the amount of the at least one porphyrin in the biological sample and the reference standard or threshold value. In some embodiments, the elevated amount is reflective of a statistically significant difference between the amount of the at least one porphyrin in the biological sample and the reference standard or threshold value. Statistical significance can be determined according to any appropriate computational or statistical approach known in the art. To illustrate, as described in EXAMPLE 1, a logistic regression model was generated for the age-adjusted associations between various porphyrin levels and AUT and/or PPD-NOS versus NT, indicating significant associations of 4-, 5-, and 6-carboxyl porphyrins with AUT. For example, the models indicated that a one-unit increase in the natural log of creatinine-adjusted value for 4-carboxyl porphyrin over the established reference standard or threshold value indicates a 2-fold increase in risk for AUT. Therefore, the statistical model, in this case a logistic regression model, provided standard or threshold value against which to compare values determined for a human (test) subject. Any additional measurements can be compared to the correct age-adjusted threshold established for the NT group, and a risk of AUT can be appropriately assigned.

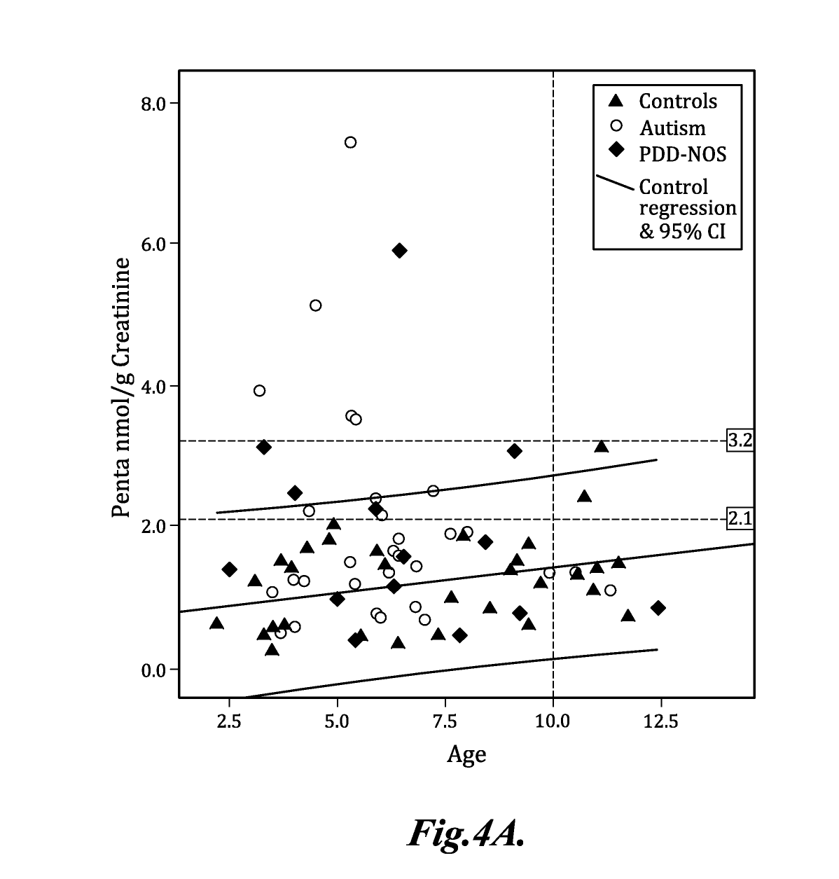

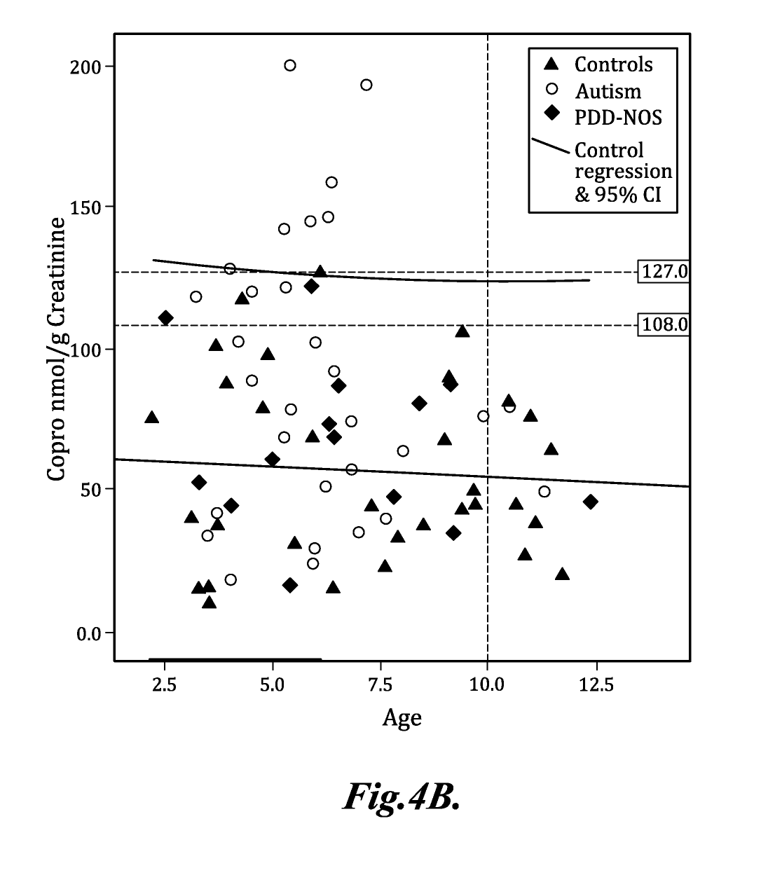

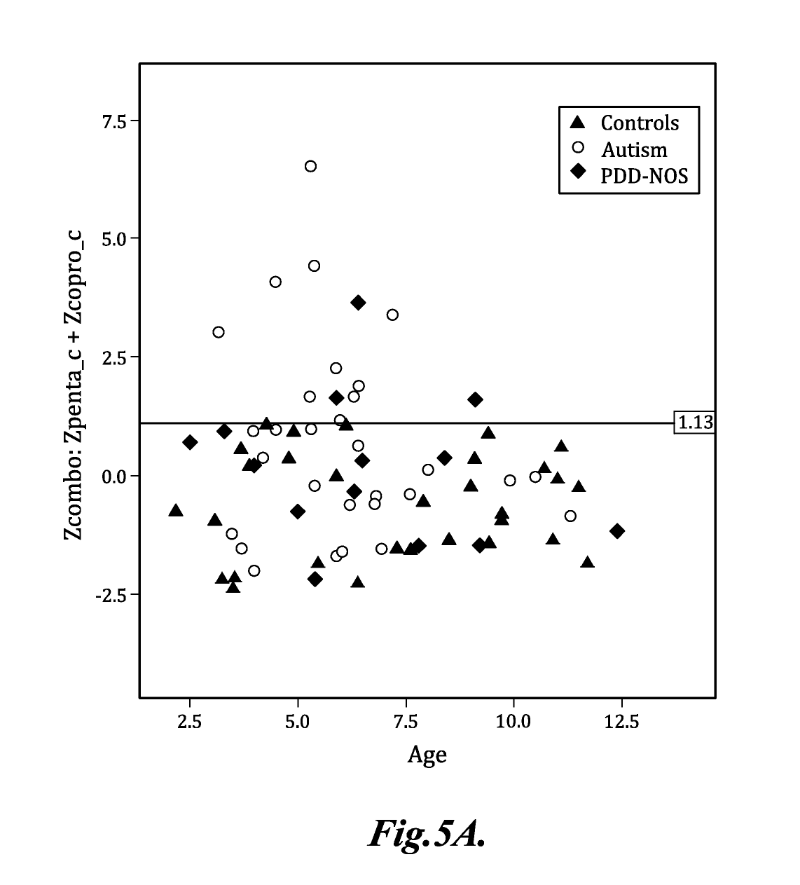

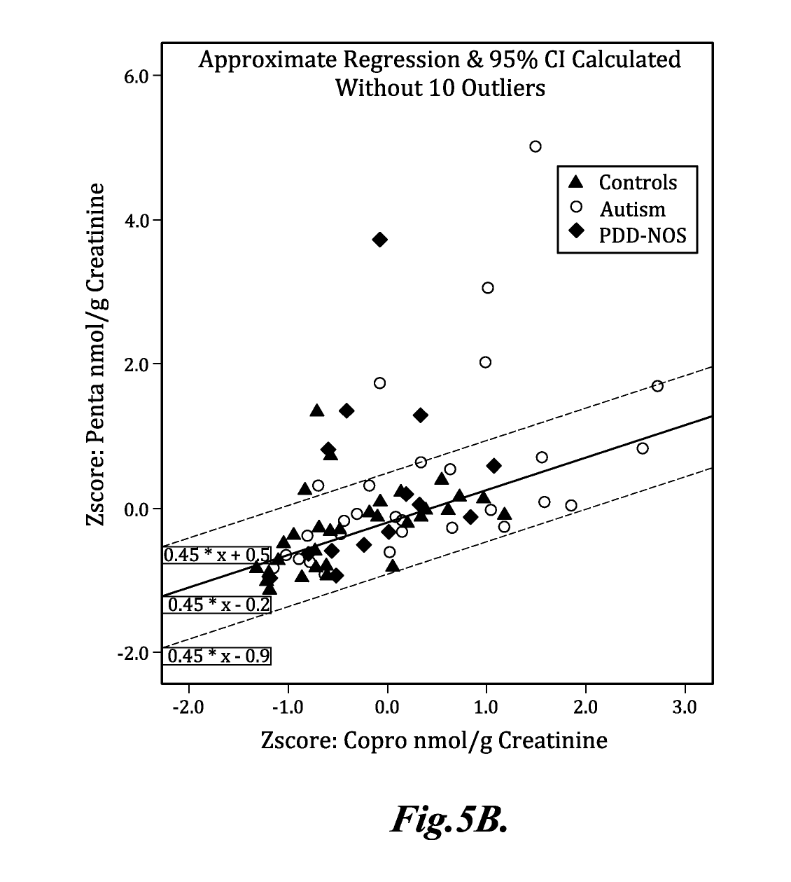

In another embodiment of the invention, as exemplified in EXAMPLE 3, regression analysis may be performed on a population of NT control subjects to show the regression of porphyrin levels over a range of ages and to establish confidence intervals (CI; 95%). From this distribution, thresholds can be established for the porphyrin value indicating AUT. For example, as described in EXAMPLE 3 and illustrated in FIG. 4A, two thresholds were established. The higher threshold was 3.2 nmol 5-carboxyl porphyrin/gram creatinine, for which all individuals having metrics exceeding the threshold were autistic. This indicates that the threshold provided 100% specificity (no false positives). A lower threshold of 2.1 nmol 5-carboxyl porphyrin/gram creatinine provided 94% specificity (two false positives). Other thresholds can be used depending on the level of specificity desired for the methods. Thresholds of similar specificity were established for nmol 4-carboxyl porphyrin/gram creatinine (127 and 108, for 100% and 94% specificity, respectively) and are illustrated in FIG. 4B. Furthermore, the combinations of porphyrin biomarkers can be combined into a single metric and compared against a reference standard or threshold value. For example, as described in EXAMPLE 3, and illustrated in FIG. 5A, the Z-scores for creatinine adjusted 5-carboxyl porphyrin and creatinine adjusted 4-carboxyl porphyrin were added into a sum value (measured in standard deviations (SD)). As described in EXAMPLE 3, a threshold of 1.13 SD was established, above which all subjects had AUT or PDD-NOS (with no NT control false-positives). A Z-score is a standardized measure that expresses values of a variable as standard deviations from that variable's mean values. Thus, the score is standardized to it's mean value (which is always zero) and it's variance. For example, Z scores can be calculated as (measured value−mean)/standard deviation. This expresses the measured value as the number of standard deviations away from the mean.

In some embodiments, a subject with an elevated amount of the at least one porphyrin compared to the reference standard or threshold value is classified as a candidate for further testing for disorders in the autistic spectrum. Additional testing for ASD includes, for example, clinical and/or psychological evaluation according to accepted standards. For example, as described above and below in EXAMPLE 1, evaluations can employ standards set forth in the Diagnostic and Statistical Manual of Mental Disorders-IV, Text Revision (DSM-IV-TR), the Autism Diagnostic Observation Schedule (ADOS), the Autism Diagnostic Interview-Revised (ADI-R) or the Childhood Autism Rating Scale (CARS). In some embodiments, further testing can include established genetic tests or functional MRI tests, as indicated above.

In accordance with various embodiments of the invention, a test subject determined to have an elevated amount of the at least one porphyrin as compared to the reference standard or threshold value is classified as a candidate for intervention treatment. Intervention treatment can include educational interventions and medical interventions. Educational interventions can include applied behavior analysis, speech and language therapy, social skills therapy, and occupational therapy. Early educational intervention can have a strong impact on future quality of life. There are a number of educational approaches that can be used including, for example, the educational approaches described in http://www.autismconnectmd.org/education/methods.html; http://www.specialed.us/autism/structure/str10.htm; http://www.autism-community.com/education/teaching-strategies/; http://www.autism.com/ind_teaching_tips.asp; http://www.abaresources.com/resources.htm; and http://autismweb.org/aba.htm.

Medical interventions often include the administration of drugs to control aspects of ASD. For example, individuals with ASD can be administered psychoactive drugs or anticonvulsants, including anti-depressants, stimulants, and antipsychotic drugs. Furthermore, as the underlying mechanisms are clarified for ASD cases manifesting increased porphyrin excretion, additional medical and behavioral interventions will likely become available. These advancements are contemplated as therapeutic treatments in this aspect of the invention.

In another embodiment, the present invention provides a method for monitoring the porphyrin levels of a test subject at multiple time points to assess the presence of, or risk of developing ASD, and/or for monitoring the efficacy of therapy for ASD. In accordance with this embodiment, the method of screening described above is performed on at least two biological samples obtained from the test subject at different times (i.e. a first biological sample taken at a first time and a second biological sample taken at a second time). The magnitude of the observed difference between an elevated level of the at least one porphyrin for the earlier biological sample compared to the reference standard or threshold value is compared to the magnitude of the observed difference between an elevated level of the at least one porphyrin in the subsequently obtained biological sample compared to the reference standard or threshold value. In some embodiments, a lesser difference between the amounts of the at least one porphyrin in the second or subsequently obtained biological sample compared to the reference standard or threshold value compared to the difference between the amounts of the at least one porphyrin compared to the reference standard or threshold value is indicative of the amelioration of the ASD and/or its symptoms, or a reduced risk of developing ASD. Thus, any applied treatments can be interpreted as having a positive effect.

Considering the ease of performance of the described method, it will be apparent to a person of skill in the art that such monitoring can be performed at numerous intervals during and after intervention treatment. For example, in some embodiments, the screening can be performed 2, 3, 4, 5, 6, 7, 8, 9, 10 or more times during or after the course of intervention treatment. Intervals for screening can be from about 2 months to several years. To illustrate, a subject can be screened every year from the age of 2 to the age of 15. It will be apparent to a person of ordinary skill that the most relevant factor for timing of the screening is the obtaining of the biological sample from the subject. The steps of determining porphyrin levels and comparing to standard references or threshold values can vary from the time of obtaining the biological sample so long as the sample is adequately preserved to reflect the porphyrin amounts.

In another aspect, the present invention provides a system for predicting the presence of, or risk of developing, an autistic spectrum disorder (ASD) in a human subject. In one embodiment, the system comprises a computer that is suitably programmed to receive input data comprising the amount of at least one porphyrin selected from a set of porphyrin biomarkers for ASD in a biological sample obtained from the subject. The amount of the at least one porphyrin can be determined independently of the suitably programmed computer by the performance of an assay, and applying the appropriate conversions or normalizations, as described above. Alternatively, aspects of the assay or data conversion can be controlled by, or be in association with, the suitably performed computer. In some embodiments, the input data also comprises additional data relating to the subject's profile, such data relating to age, medical history, familial medical history, the presence of additional disorders, and various environmental factors. Upon receipt of the input data, the suitably programmed computer follows a set of instructions to computationally compare the amount of the at least one porphyrin to a reference standard or threshold value.

The reference standard or threshold value can be input independently of, or concurrently with, the input data regarding the at least one porphyrin in the biological sample obtained from the subject. In some embodiments, the suitably programmed computer further includes a database comprising the amounts of at least one porphyrin selected from a set of porphyrin biomarkers for ASD in biological sample obtained from a plurality of neurotypical subjects.

In some embodiments, the input of data pertinent to “at least one porphyrin” comprises input of the levels determined for all five porphyrins in the biological sample, wherein a determination that at least two (5-carboxyl and 4-carboxyl) porphyrins are elevated at a statistically significant level as compared to a reference standard is indicative of the presence of, or increased risk of developing ASD.

In some embodiments, the database further comprises additional detailed information regarding the neurotypical subjects' profiles, such as data relating to age, the presence or absence of non-ASD developmental disorders, developmental milestones, sex, IQ, presence of ASD siblings, and drug and toxin exposure or burden.

As described above, the system comprises a set of instructions to analyze the presence of, or risk of developing, ASD in the subject based on the input data and the reference standard or threshold value. In some cases, analysis of the presence of, or risk of developing, ASD in the subject involves generating a reference standard or threshold value from the database or a portion thereof. In some embodiments, the reference standard or threshold value is generated from a portion of the database that is selected to include a population of NT control profiles that are appropriately matched to the profile of the (test) subject. To illustrate, upon input of the test subject's porphyrin levels, sex and age, the suitably programmed computer follows instructions to generate a reference standard or threshold value for the porphyrin levels based only on the control NT subject profiles that have an equivalent age and are of the same sex and include data for the same at least one porphyrin level, or at least two porphyrin level(s).

It is preferred that the set of instructions also comprise instructions to perform an appropriate statistical computation that compares the amount of the at least one porphyrin, or at least two porphyrins determined in the biological sample obtained from the subject and the reference standard or threshold value. Appropriate statistical comparisons are described above and in the Examples.

Previously, fluctuations in porphyrins observed in subjects with ASD were correlated with increased burden of toxins, such as heavy metals. As described herein, the present inventors have unexpectedly discovered that elevated levels of certain porphyrins are associated with ASD, independent of heavy metal exposure or burden. These results provide a strong indication for the role of aberrant porphyrin/heme metabolism in a subset of ASD cases independent of heavy metal exposure or burden. Accordingly, in another aspect, the present invention provides a method of predicting ASD in a subject based on detecting an aberrant porphyrin metabolism. In one embodiment, the aberrant porphyrin metabolism in a subject is determined by the detection of elevated porphyrin levels in a biological sample, such as urine, obtained from the subject. This embodiment of the method can be performed as described above. In other embodiments, the aberrant porphyrin metabolism can be detected by the identification of genetic factors that negatively affect porphyrin uptake by mitochondria. In other embodiments, the aberrant porphyrin metabolism can be detected by the identification of genetic factors that negatively affect a step of heme biosynthesis that results in an accumulation of intermediate porphyrin substrates upstream in the biosynthesis pathway.

The following examples merely illustrate the best mode now contemplated for practicing the invention, but should not be construed to limit the invention. All literature citations are expressly incorporated by reference.

### EXAMPLE 1

This example describes the discovery of a correlation between urinary porphyrin levels and presence or risk of autistic spectrum disorder in human subjects independent of detectable heavy metal exposure.

Rationale:

The present study was initiated to address several issues associated with the use of urinary porphyrin changes as a diagnostic biomarker of Hg exposure among children and, in particular, those with autism.

Methods:

The study population. The principal source of subjects for this study was approximately 600 families with autistic children who subscribe to the informational services of the Autism Research Institute (ARI), Lacey, Wash. (USA). A convenience sample of subjects, specifically NT, AUT, and Pervasive Developmental Disorder-Not Otherwise Specified (PDD-NOS) children, ages 2-12 years, were recruited into the study via a flyer. Instructions were sent by the study coordinator at the ARI to all subscribing ARI families, informing them about the study and inviting them to participate. The flyer directed interested parents/caregivers to respond by e-mail or telephone regarding their interest in participating. The study coordinator then contacted interested parents to describe the study and obtain consent. Consenting participants were asked to complete an online enrollment form and to provide a urine sample from the child/children in their families The estimated participation rate for the ARI was 37%.

The online enrollment form contained detailed questions pertaining to the child's diagnosis, including diagnostic criteria, diagnosing facility, name of diagnosing clinician, month/year of diagnosis, and diagnostic procedure(s) used. Additional questions were asked regarding dietary practices, drug exposures including chelation history, dental amalgam history, and child's inoculation history. The number of vaccinations was collected as a potential source of Hg exposure; a distinction was made between total vaccinations and vaccinations prior to the year 2002 when thimerosal, a preservative containing an organomercurial moiety, was eliminated from many vaccines. In addition, to estimate maternal exposures to Hg during the 9 months of the index pregnancy, a count of dental amalgam tooth fillings (a potential source of Hg⁰ exposure) and an estimate of fish meals per week (a potential source of methylmercury exposure) for the mother were obtained for this time period.

Urine samples were collected in the home, transferred to the ARI by hand, and assigned a coded identification (ID) number by the ARI. The samples were sent to the University of Washington for analysis, identified only by ID number, age, sex, and diagnosis. Data derived from these studies were evaluated in relation to the diagnostic information provided in the online enrollment form to establish mean porphyrin levels for NT children and to determine the association of urinary porphyrin concentrations with autism or related neurobehavioral disorders.

To augment the number of subjects for whom porphyrin comparisons could be made, porphyrin concentrations were analyzed in urine samples acquired from an additional 41 subjects recruited through the Center for Autism and Related Disorders (CARD) in Tarzana, Calif. (USA), and an additional 24 subjects, also through the CARD, from the Rimland Center for Integrative Medicine in Lynchburg, Va. (USA). CARD subjects were restricted to 2- to 12-year-old NT or AUT males who had never undergone chelation treatment and were without amalgam dental fillings. CARD subjects were recruited prior to the initiation of the ARI study and hence did not complete the online enrollment questionnaire used by ARI participants. The estimated participation rate for the CARD was 31%.

Methods of subject recruitment as well as timing and manner of urine collection and processing were comparable between the CARD and ARI cohorts, and preliminary analyses of mean urinary porphyrin and Hg levels by subject source indicated no significant differences within age groupings. Therefore, data from both sources were pooled for porphyrin and Hg analyses. Overall, enrolled 278 children were enrolled in the study. After 55 children who had been previously chelated were excluded, 197 children were eligible for analysis. Final statistical models were performed using males only and included 59 NT, 59 AUT, and 15 PDD-NOS subjects.

Certain drugs that are sometimes administered to autistic children as mood stabilizers or antidepressants, such as valproic acid (depakote, convulex) and risperidone (risperdal), may affect prophyrin metabolism. Participants in this study were selected from among subjects who did not receive such drugs. It is very unlikely, therefore, that such medications contributed to the disordered porphyrin metabolism observed among autistic children.

Human subjects considerations. The study protocol was approved by the institutional review boards at the University of Washington and the CARD. Human subjects' approval of the ARI protocol was conferred via an individual investigator agreement between the study coordinator at the ARI and the University of Washington. All parents/caretakers gave written consent for themselves and their children prior to enrollment in the study.

Diagnostic procedures. For children enrolled through the ARI, diagnosis of autism or other neurodevelopmental disorders was performed by established autism diagnostic and treatment centers that included the University of Washington Autism Center, the Seattle Children's Autism Center [formerly the Autism Spectrum Treatment and Research Center (ASTAR)], and other pediatric neurology clinics throughout the Pacific Northwest. The diagnosis of AUT, PDD-NOS, or other disorder at these centers was made using a multidisciplinary approach that combines a clinical evaluation using the Diagnostic and Statistical Manual of Mental Disorders, Fourth Edition, Text Revision (DSM-IV-TR) (American Psychiatric Association 2000) criteria, along with a psychological evaluation using the Autism Diagnostic Observation Schedule (ADOS) (Lord, C., et al., “The Autism Diagnostic Observation Schedule-Generic: a Standard Measure of Social and Communication Deficits Associated With the Spectrum of Autism,” Journal of Autism and Developmental Disorders 30:205-223, 2000), and other established diagnostic procedures such as the Autism Diagnostic Interview-Revised (Lord, C., “Autism Diagnostic Interview-Revised: a Revised Version of a Diagnostic Interview for Caregivers of Individuals With Possible Pervasive Developmental Disorders,” Journal of Autism and Developmental Disorders 24:659-685, 1994) or the Childhood Autism Rating Scale (Schopler, E., et al., The Childhood Autism Rating Scale (CARS),” Los Angeles, Calif.:Western Psychological Services, 1993). Verification of AUT status by further psychological testing of children enrolled through the ARI was not feasible in this study. However, comparison of dates of AUT diagnosis revealed that >90% of subjects had been diagnosed since 2003, that is, within the immediate 5-year period since inception of this study, supporting continuity in the methods and procedures used and, therefore, homogeneity in the AUT diagnosis. These observations further serve to verify the distinction between diagnoses of AUT and other neurodevelopmental disorders, particularly PDD-NOS, as the same testing procedures and treatment centers were employed to diagnose PDD-NOS, most also occurring since 2003. No subjects were diagnosed before 2001.

For subjects enrolled through the CARD, all diagnosed children were fully evaluated by a trained psychologist and met the International Classification of Diseases, 9th Revision (World Health Organization, 1975) and DSM-IV-TR (American Psychiatric Association, 2000) criteria for autism. All diagnoses were verified by obtaining copies of the diagnoses and subsequently validated by additional evaluations at the CARD using the ADOS and other diagnostic procedures cited above.

Participants recruited through the ARI were invited to enroll children with a previous diagnosis of autism or other neurodevelopmental disorder as well as their typically developing siblings. Children whose parents responded “No” to the question “Is this child diagnosed with any neurodevelopmental disorder?” were designated neurotypical (NT). Verification of NT status through further psychological testing of children enrolled through this process was not conducted. NT subjects enrolled through the CARD were children of CARD employees, all of whom were trained observers and aware of their children's development. In this respect, all children designated as NT met all developmental milestones, had no symptoms of ASD, ADHD (attention deficit hyperactivity disorder), or (other) learning disabilities, and were seen to be performing successfully in school or preschool with normal peer play. Opportunities for misclassification, therefore, were minimal The possibility exists that siblings may differ from unrelated controls from the same source population in their genetic contribution to specific inherited disorders such as those affecting porphyrin metabolism. It is noted in this regard that genetic variation in porphyrin metabolism, particularly that affecting urinary porphyrin excretion, is exceedingly rare especially within the U.S. population, affecting, in the case of the most prevalent form, <1 in 100,000 individuals (0.001%) (Health Grades, Inc., <http://www.wrongdiagnosis.com/p/porphyria_cutanea_tarda_familial_type/prevalence.htm> [retrieved Jun. 21, 2010]). Although the absence of differences in genetic variance in related and unrelated NT subjects in this study was not verified, it is unlikely that siblings and unrelated controls differed significantly in this respect.

Procedures for urine collection and measurement of urinary porphyrins, Hg, and creatinine concentrations. Urine samples (˜50 mL, first or second morning voids when possible) were collected by parents/caregivers in clean glass containers and then transferred to Nalgene Nunc 60-mL, wide-mouth polyethylene bottles with screw-on lids (Item 2106-0002; Fisher Scientific, Seattle, Wash., USA). Samples were delivered frozen to the ARI where they were logged, assigned an ID number, and shipped in batch in frozen ice packs by overnight express service to the University of Washington. A comparable protocol was followed by the CARD. For analyses, a 10-mL aliquot was removed and acidified with 1N HCl for Hg analysis by continuous-flow, cold-vapor spectrofluorometry (Pingree, S. D., et al., “Effects of 2,3-Dimercapto-1-Propanesulfonic Acid (DMPS) on Tissue and Urine Mercury Levels Following Prolonged Methylmercury Exposure in Rats,” Toxicological Sciences 61:224-233, 2001b). Porphyrins were quantified in the remaining unacidified portion of the urine sample by HPLC-spectrofluorometric analysis, as previously described (Bowers et al., 1992; Woods, J. S., et al., “Urinary Porphyrin Profiles as Biomarkers or Trace Metal Exposure and Toxicity: Studies on Urinary Porphyrin Excretion Patterns in Rats During Prolonged Exposure to Methyl Mercury,” Toxicology and Applied Pharmacology 110:464-476, 1991). Urinary creatinine concentrations were also measured in unacidified urine using a standard colorimetric procedure (Sigma, St. Louis, Mo., USA). Urinary porphyrin concentrations were first creatinine adjusted (nanomoles per gram) and then transformed using the natural logarithm because of the wide variation and skewed distribution. Hg values below the detection limit (LOD) (0.02 μg/L) were assigned LOD/√−2.

Statistical procedures. Statistical analyses were conducted using PASW Statistics 17.0 (formerly SPSS) (IBM, Chicago, Ill., USA). Descriptive assessments first eliminated statistical outliers (values ≧3 SD in both directions) and then used cross-tabulations and one-way analysis of variance (ANOVA) procedures to compare nonchelated children from the three confirmed diagnostic groups [AUT (n=64), PDD-NOS (n=19), and NT (n=114)] with regard to sex, age, potential sources of Hg exposure, and mean(±SD) urinary Hg and porphyrin levels. The small number of five females in the AUT group precluded subsequent statistical analyses for each sex. Thus, the potential determinants of diagnostic status were examined among only the 133 male children (59 AUT, 15 PDD-NOS, and 59 NT).

In males, logistic regression models that controlled for age initially tested potential associations between diagnosis and sources of exposure to Hg from the number of dental amalgam tooth fillings in the child and the mother, the number of vaccines that the child was reported to have received, the number of fish meals per month, and urinary Hg concentrations. The mean(±SD) of each porphyrin was also stratified by diagnosis, age, and sex, where an ANOVA F-test was applied separately for each sex to identify statistically significant differences between diagnostic groups.

Logistic regression analyses were also used to evaluate potential associations among males between porphyrins and the risk of having a diagnosis of AUT or PDD-NOS, using NT as controls. Statistical measures included regression coefficients, their SDs, and estimates of the strength of association expressed as odds ratios (ORs) and 95% confidence intervals (CIs) for each porphyrin model. A statistically significant association was accepted if p<0.05. Apart from the expected effect of age and age-squared, which were retained in final models, the only covariate that approached statistical significance was a restricted diet (p<0.065). This variable was more reasonably attributed to response to diagnosis rather than to etiology or causal association and therefore was not retained in the analyses. The analyses also evaluated the combination of the three lesser carboxyl porphyrins (hexa-, penta-, and copro-) for potential association with AUT or PDD-NOS. Urinary porphyrin concentrations normalized for creatinine (nanomoles per gram) along with the natural logs of these values were tested in the analyses.

Results:

The study population. Table 1 describes the demographic distributions for the study population by diagnosis category.

TABLE 1
Demographic distributions for all subjects.

| Total Subjects | NT (n = 117) | AUT (n = 100) | PDD (n = 27) | Other (n = 34) | Total (n = 278) |
|---|---|---|---|---|---|
| Males | 61 (52) | 93 (93) | 22 (81) | 25 (74) | 201 (72) |
| Females | 56 (48) | 7 (7) | 5 (19) | 8 (24) | 77 (28) |
| Chelated | 3 (3) | 36 (36) | 8 (30) | 8 (24) | 55 (20) |
| Age (years) | 6.67 ± 2.96 | 6.33 ± 2.36 | 6.88 ± 3.07 | 7.78 ± 2.60 | 6.70 ± 2.75 |

Values are n (%) or mean ± SD.

Among all children enrolled, 278 had urinary measures of porphyrins and Hg. Among these subjects, 117 were determined to have NT development, 100 met the criteria for AUT, and 27 were determined to have PDD-NOS. An additional 34 had other neurodevelopmental diagnoses that included Rett syndrome (n=1), Asperger's syndrome (n=4), attention deficit hypersensitivity disorder (ADD/ADHD) (n=12), sensory integration disorder (n=5), and language and speech delay (n=3). Fifty-five subjects had undergone chelation therapy, including 3 NT, 36 AUT, 8 PDD-NOS, and 8 other. Only the 197 children who had not been chelated and who had diagnoses of NT, AUT, or PDD-NOS were included in further analyses, depicted in Table 2.

TABLE 2
Demographic and potential risk factors among nonchelated subjects in study.

| Nonchelated subjects | Sex | NT n = 114) | AUT (n = 64) | PDD (n = 19) | Total (n = 197) |
|---|---|---|---|---|---|
| No. | M | 59 (52) | 59 (92) | 15 (79) | 133 (67) |
| | F | 55 (48) | 5 (8) | 4 (21) | 64 (33) |
| Age (years) | M | 6.39 ± 3.06 | 6.01 ± 2.14 | 6.16 ± 3.03 | 6.19 ± 2.67 |
| | F | 6.93 ± 2.85 | 4.60 ± 1.82 | 8.73 ± 4.98 | 6.86 ± 3.00 |
| Urinary Hg (μg/L) | M | 0.29 ± 0.53 | 0.36 ± 0.62 | 0.27 ± 0.26 | 0.32 ± 0.55 |
| | F | 0.21 ± 0.45 | 0.09 ± 0.10 | 0.30 ± 0.48 | 0.21 ± 0.43 |
| Urinary Hg (μg/g | M | 0.28 ± 0.43 | 0.40 ± 0.66 | 0.32 ± 0.33 | 0.34 ± 0.53 |
| creatinine) | F | 0.21 ± 0.48 | 0.12 ± 0.14 | 0.29 ± 0.51 | 0.21 ± 0.46 |
| Creatinine (g/Lr) | M | 1.01 ± 0.48 | 0.95 ± 0.38 | 0.96 ± 0.41 | 0.98 ± 0.43 |
| | F | 1.03 ± 0.40 | 0.86 ± 0.30 | 1.51 ± 0.75 | 1.04 ± 0.43 |
| Amalgams in child | M | 0.18 ± 0.6 | 0.20 ± 1.1 | 0.53 ± 1.3 | 0.25 ± 0.9 |
| | F | 0.23 ± 1.2 | 0.0 ± 0.0 | 0.0 ± 0.0 | 0.19 ± 1.1 |
| Amalgams in mother | M | 2.9 ± 4.2 | 4.3 ± 5.3 | 4.0 ± 4.4 | 3.6 ± 4.6 |
| when pregnant | F | 4.1 ± 4.6 | 4.6 ± 2.7 | 3.7 ± 0.6 | 4.2 ± 4.3 |
| Total vaccines | M | 6.5 ± 6.9 | 10.1 ± 7.8 | 6.5 ± 6.9 | 7.9 ± 7.4 |
| | F | 8.9 ± 7.1 | 12.2 ± 3.3 | 5.8 ± 8.0 | 8.9 ± 6.9 |
| Vaccines before 2002 | M | 3.5 ± 5.2 | 1.8 ± 3.9 | 1.5 ± 4.1 | 2.5 ± 4.6 |
| | F | 4.1 ± 5.5 | 2.0 ± 3.5 | 0.0 ± 0.0 | 3.6 ± 5.2 |
| Restricted diet (%) | M | 24 | 48 | 60 | 41 |
| | F | 25 | 80 | 100 | 36 |
| Eat fish (%) | M | 59 | 40 | 25 | 55 |
| | F | 70 | 58 | 53 | 62 |

Values are n (%), mean ± SD, or %.

Only 5 AUT and 4 PDD-NOS cases were girls, consistent with the much lower frequency of autism and related disorders among females. Therefore, although female subjects are included in descriptive analyses of porphyrin levels (Table 3), they were not included in the logistic regression analyses. Thus, logistic regression analyses (Table 4) were conducted among the group of 133 male children that included 59 AUT, 15 PDD-NOS, and 59 NT.

TABLE 3
Mean ± SD of porphyrin concentrations (nanomoles per gram creatinine) by NT or
AUT status, sex, and age (years).

| | | n | Age | Uro | Hepta | Hexa | Penta | Preco | Copro |
|---|---|---|---|---|---|---|---|---|---|
| NT | Male | 2 | <2 | 22.27 ± 18.23 | 4.49 ± 3.69 | 0.96 ± 0.47 | 2.72 ± 1.18 | 25.18 ± 9.09 | 250.18 ± 16.16 |
| | | 16 | 2-3.9 | 9.27 ± 6.35 | 2.66 ± 1.75 | 1.12 ± 1.18 | 1.90 ± 1.36 | 8.84 ± 7.14 | 114.16 ± 100.83 |
| | | 11 | 4-5.9 | 9.89 ± 4.08 | 2.86 ± 1.17 | 1.37 ± 0.87 | 2.37 ± 1.68 | 9.56 ± 8.77 | 102.47 ± 73.40 |
| | | 13 | 6-7.9 | 10.10 ± 6.03 | 2.74 ± 1.18 | 1.28 ± 1.00 | 2.49 ± 1.86 | 8.75 ± 7.02 | 83.44 ± 56.32 |
| | | 7 | 8-9.9 | 9.11 ± 6.37 | 2.01 ± 1.50 | 0.55 ± 0.39 | 1.19 ± 0.39 | 7.94 ± 5.87 | 62.58 ± 26.26 |
| | | 10 | ≧10 | 9.03 ± 2.94 | 2.09 ± 0.80 | 0.52 ± 0.27 | 1.43 ± 0.84 | 6.05 ± 2.40 | 46.11 ± 21.99 |
| | | 59 | Total | 9.95 ± 6.14 | 2.60 ± 1.45 | 1.03 ± 0.92 | 1.98 ± 1.44 | 8.93 ± 7.30 | 92.17 ± 76.61 |
| AU | Male | 6 | 2-3.9 | 12.31 ± 7.00 | 4.82 ± 3.02 | 3.00 ± 2.85 | 6.07 ± 5.22 | 13.84 ± 9.46 | 171.85 ± 152.02 |
| | | 23 | 4-5.9 | 9.24 ± 7.41 | 2.61 ± 1.25 | 1.27 ± 0.79 | 2.91 ± 1.87 | 9.47 ± 7.13 | 127.66 ± 89.58 |
| | | 21 | 6-7.9 | 8.31 ± 3.22 | 2.74 ± 1.22 | 1.25 ± 0.83 | 2.75 ± 1.74 | 9.73 ± 6.35 | 108.89 ± 55.81 |
| | | 5 | 8-9.9 | 13.14 ± 7.16 | 4.75 ± 3.50 | 2.40 ± 2.14 | 5.10 ± 4.22 | 14.31 ± 13.70 | 126.66 ± 86.21 |
| | | 4 | ≧10 | 11.87 ± 4.41 | 3.37 ± 1.43 | 1.46 ± 0.93 | 2.89 ± 2.27 | 10.06 ± 3.09 | 80.82 ± 28.36 |
| | | 59 | Total | 9.73 ± 6.00 | 3.12 ± 1.88 | 1.55 ± 1.37 | 3.36 ± 2.73 | 10.46 ± 7.58 | 122.21 ± 84.35 |
| | ANOVA | p-Value | | 0.57 | 0.06 | 0.01 | 0.001 | 0.10 | 0.009 |
| | F-test | | | | | | | | |
| NT | Female | 7 | 2-3.9 | 10.65 ± 3.45 | 2.20 ± 0.58 | 0.59 ± 0.16 | 1.94 ± 0.71 | 8.95 ± 2.55 | 119.71 ± 44.98 |
| | | 18 | 4-5.9 | 11.79 ± 7.24 | 2.70 ± 1.77 | 0.95 ± 1.16 | 1.67 ± 1.08 | 8.90 ± 5.00 | 73.96 ± 41.08 |
| | | 10 | 6-7.9 | 11.25 ± 7.82 | 2.18 ± 1.25 | 1.59 ± 2.86 | 1.53 ± 0.65 | 5.33 ± 1.98 | 64.67 ± 44.37 |
| | | 9 | 8-9.9 | 13.93 ± 6.49 | 3.19 ± 0.91 | 0.95 ± 0.28 | 2.05 ± 0.67 | 9.16 ± 4.13 | 77.86 ± 41.45 |
| | | 11 | ≧10 | 9.48 ± 5.91 | 2.12 ± 1.10 | 0.61 ± 0.41 | 1.34 ± 0.86 | 4.86 ± 3.49 | 51.24 ± 31.41 |
| | | 55 | Total | 11.43 ± 6.53 | 2.51 ± 1.34 | 0.95 ± 1.39 | 1.67 ± 0.87 | 7.49 ± 4.21 | 74.19 ± 43.77 |
| AU | Female | 2 | 2-3.9 | 20.63 ± 22.04 | 3.44 ± 3.66 | 0.61 ± 0.85 | 1.63 ± 1.61 | 3.09 ± 0.22 | 101.60 ± 49.43 |
| | | 2 | 4-5.9 | 14.12 ± 2.76 | 2.94 ± 1.14 | 0.89 ± 0.24 | 1.73 ± 1.09 | 10.10 ± 4.21 | 119.87 ± 85.62 |
| | | 1 | 6-7.9 | 17.24 | 4.04 | 0.89 | 1.56 | 5.69 | 83.09 |
| | | 5 | Total | 17.34 ± 11.57 | 3.36 ± 1.97 | 0.78 ± 0.47 | 1.65 ± 0.97 | 6.41 ± 4.11 | 105.20 ± 51.77 |
| | ANOVA | p-Value | | 0.07 | NS | NS | NS | NS | |
| | F-test | | | | | | | | |

NS, not significant.

TABLE 4
Logistic regression coefficients and ORs between
AUT, AUT + PDD pooled, and PDD alone (all vs.
NT) for urinary excretion of porphyrins among males.

| | | Porphyrin parameters | | | |
|---|---|---|---|---|---|
| Porphyrin | Diagnostic | | | | p- |
| model^{a} | group^{b} | OR (95% CI) | B | SE | Value |
| Uro | AU | 1.06 (0.58-1.96) | 0.06 | 0.31 | 0.84 |
| | AUT + PDD | 1.04 (0.58-1.86) | 0.04 | 0.30 | 0.90 |
| | PDD | 1.06 (0.42-2.69) | 0.06 | 0.48 | 0.91 |
| Hepta | AU | 1.83 (0.93-3.58) | 0.60 | 0.34 | 0.08 |
| | AUT + PDD | 1.57 (0.83-2.97) | 0.45 | 0.32 | 0.16 |
| | PDD | 0.81 (0.30-2.20) | −0.22 | 0.51 | 0.67 |
| Hexa | AU | 1.65 (1.07-2.55) | 0.50 | 0.22 | 0.02 |
| | AUT + PDD | 1.58 (1.05-2.38) | 0.46 | 0.21 | 0.03 |
| | PDD | 1.28 (0.66-2.47) | 0.25 | 0.34 | 0.47 |
| Penta | AU | 2.36 (1.37-4.07) | 0.86 | 0.28 | 0.00 |
| | AUT + PDD | 1.86 (1.16-3.00) | 0.62 | 0.24 | 0.01 |
| | PDD | 0.90 (0.42-1.92) | −0.10 | 0.39 | 0.79 |
| Preco | AU | 1.51 (0.91-2.52) | 0.41 | 0.26 | 0.11 |
| | AUT + PDD | 1.18 (0.76-1.82) | 0.16 | 0.22 | 0.47 |
| | PDD | 0.56 (0.27-1.16) | −0.58 | 0.37 | 0.12 |
| Copro | AU | 2.03 (1.15-3.57) | 0.71 | 0.29 | 0.01 |
| | AUT + PDD | 1.68 (1.01-2.80) | 0.52 | 0.26 | 0.05 |
| | PDD | 0.83 (0.38-1.83) | −0.19 | 0.40 | 0.65 |
| Hexa/penta/copro | AU | 2.38 (1.42-3.97) | 0.87 | 0.26 | 0.00 |

^{a}All models include age and age-squared plus the natural log of the creatinine-corrected concentration for individual porphyrins.
^{b}Number of subjects in each diagnostic group: male NT = 59; male autistic = 59; male PDD-NOS = 15.

As noted above in Table 2, age distributions by diagnosis were similar among male subjects. In addition, most covariates were not statistically different between diagnostic groups. In particular, mean urinary past Hg levels, whether unadjusted (micrograms per liter) or adjusted for creatinine (micrograms per gram), were surprisingly not significantly different between groups. This was also true for the potential sources of Hg exposure, including the mean number of amalgam fillings (both currently in the child or in the mother over the course of pregnancy) and the mean sum of vaccines administered to the child in total, or before 2002.

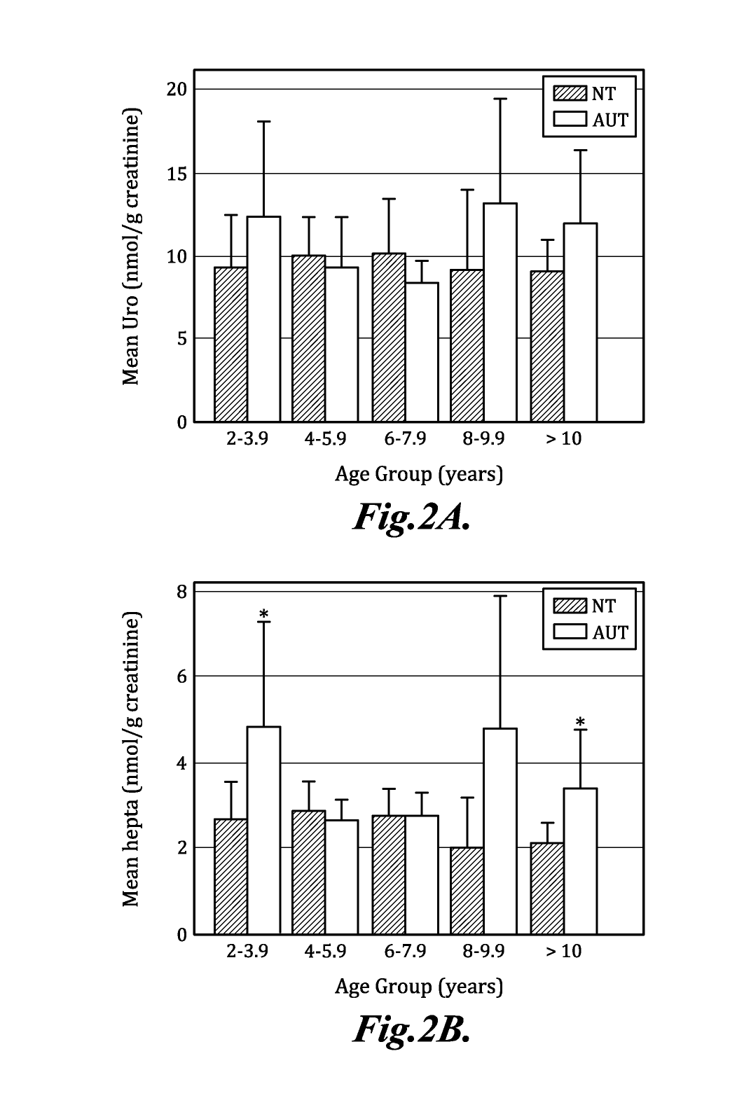

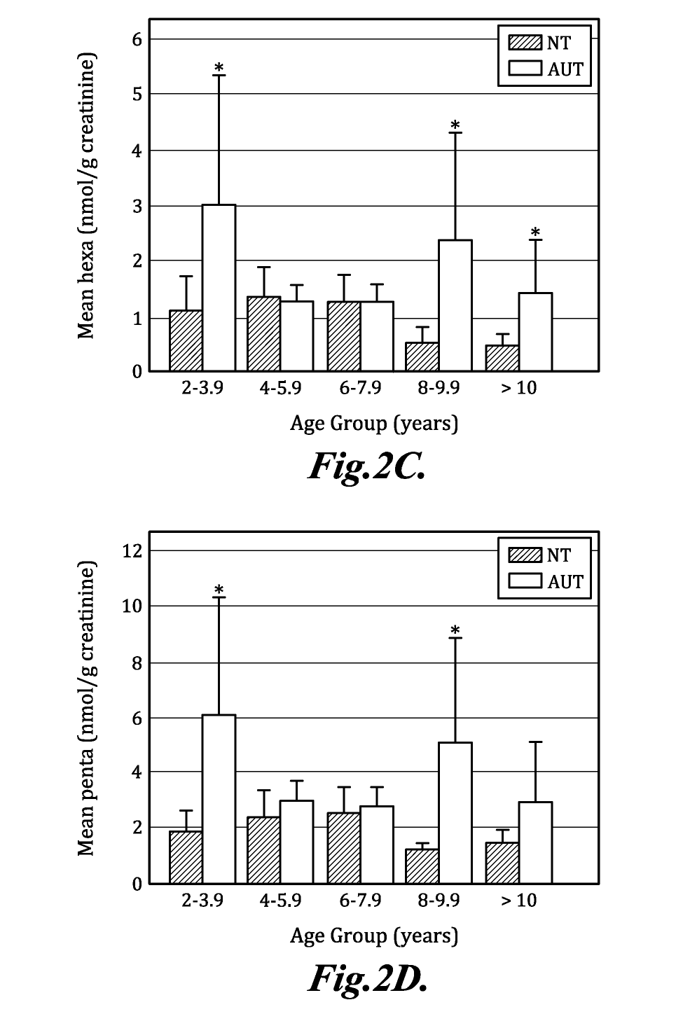

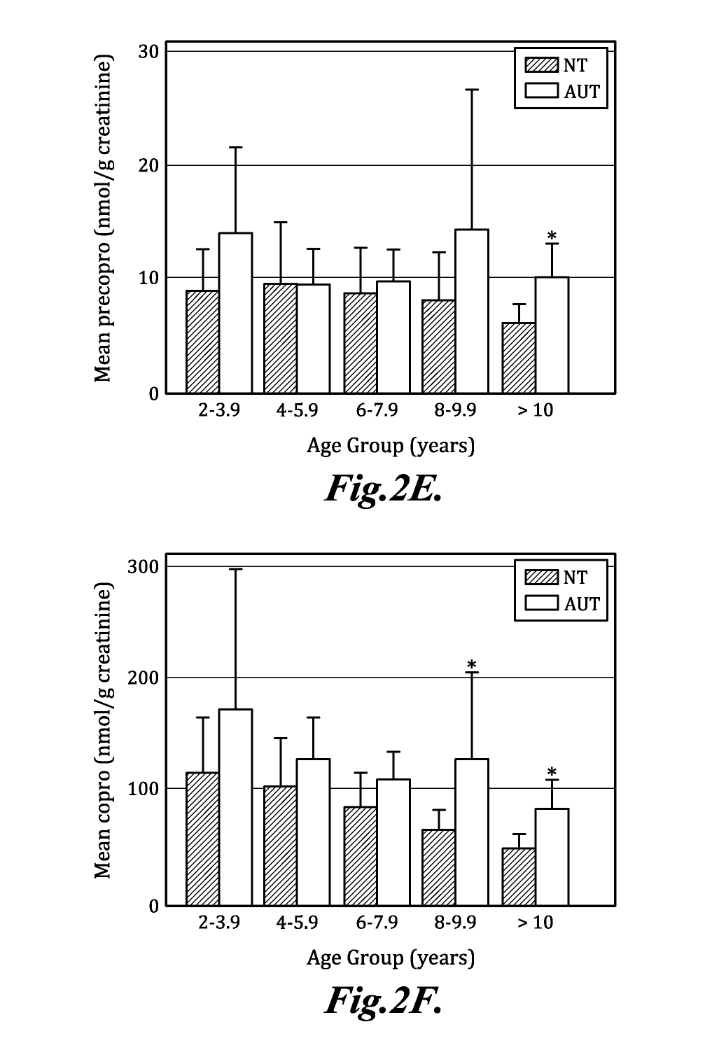

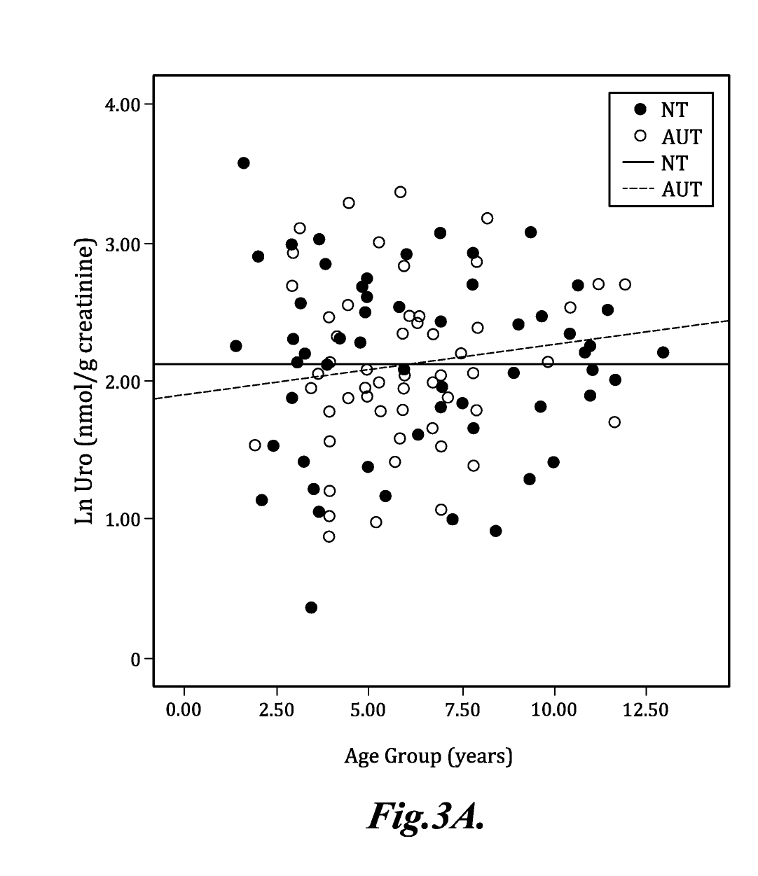

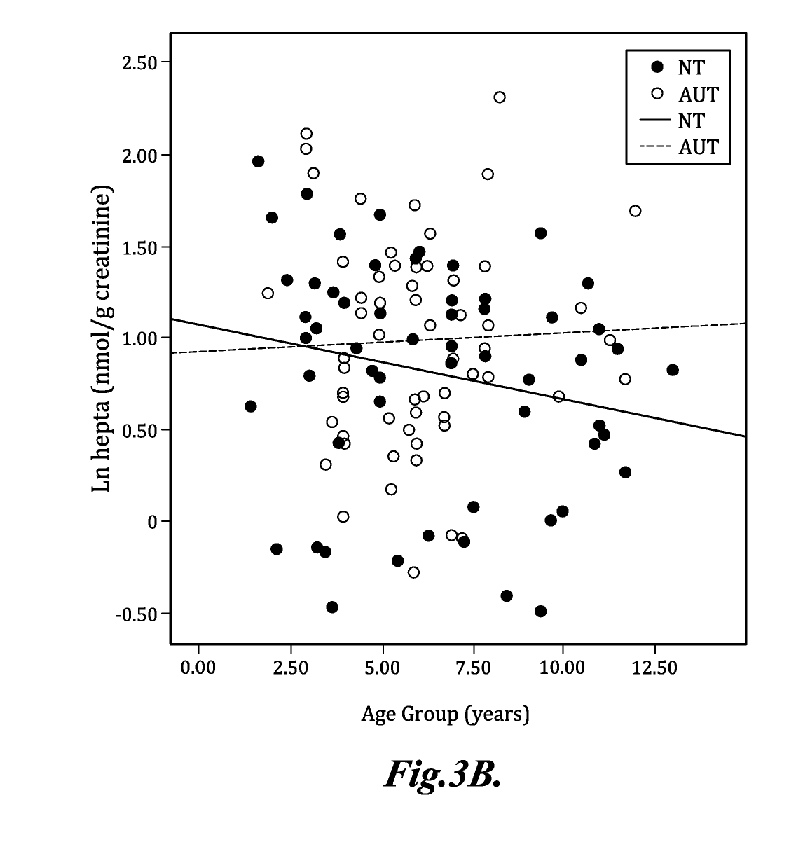

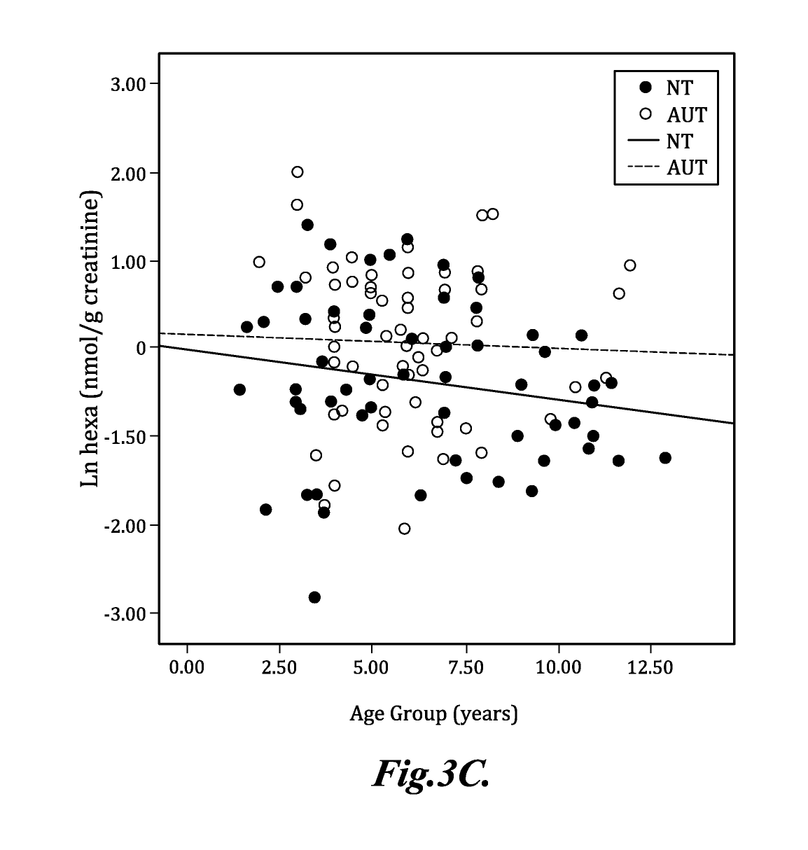

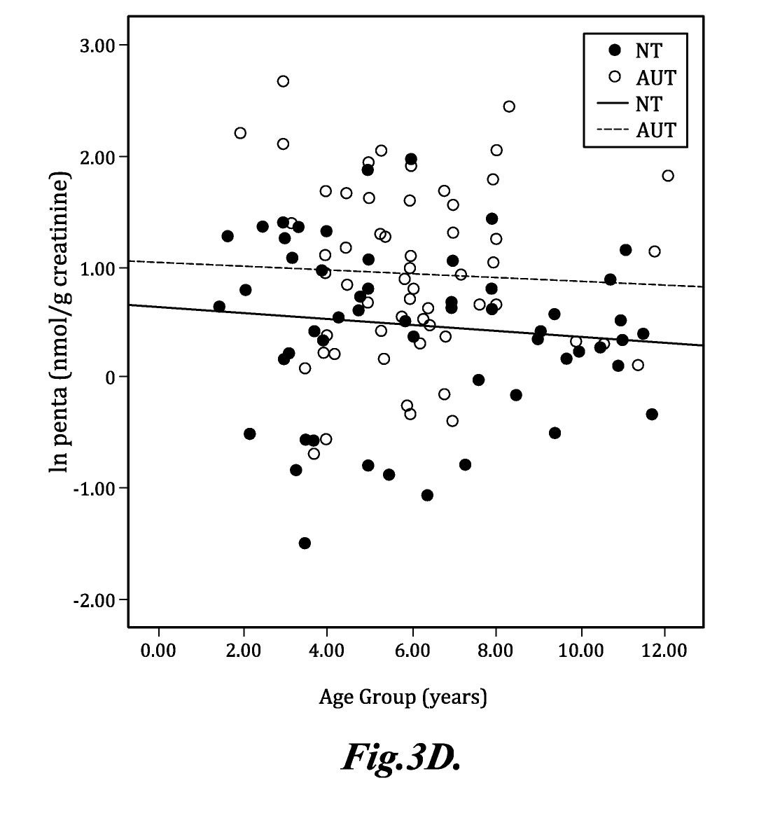

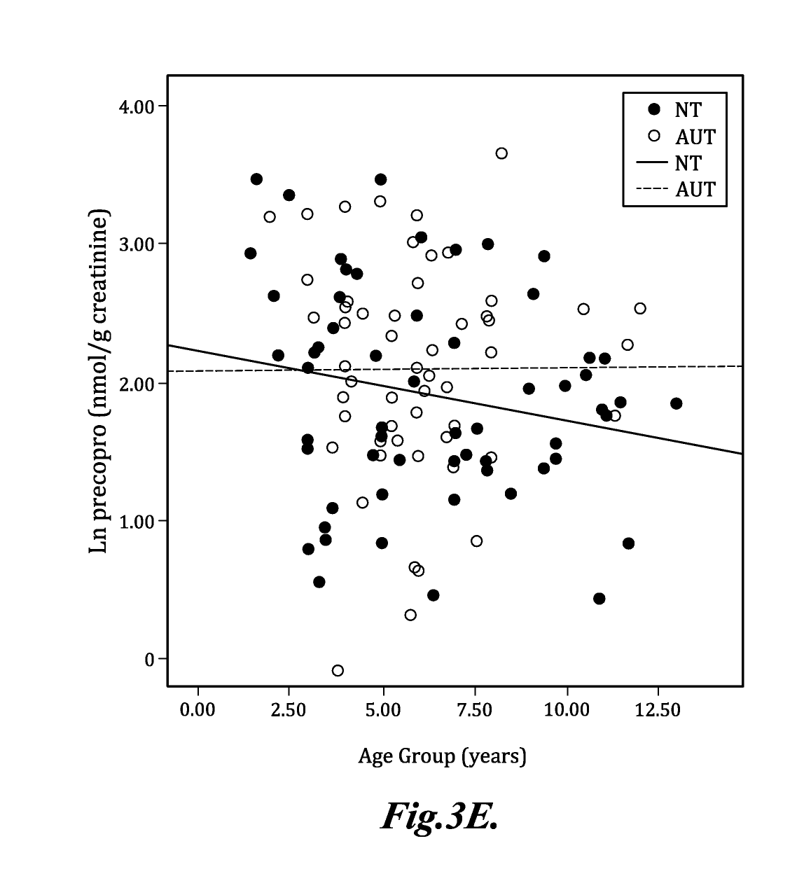

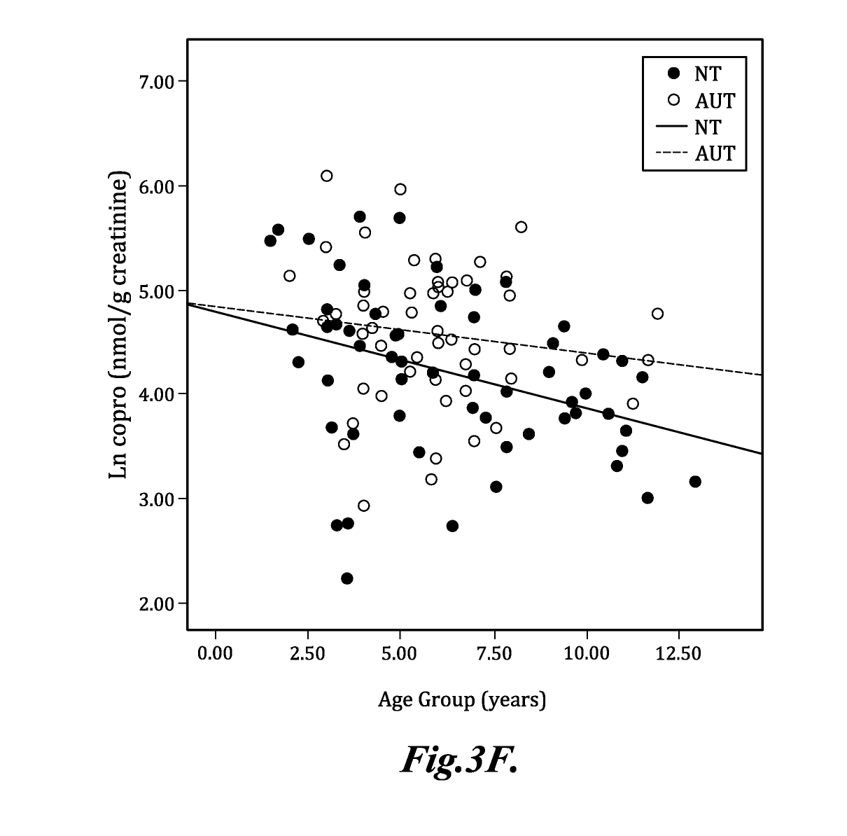

Urinary porphyrin concentrations in children. The distribution of six urinary porphyrins is presented in Table 3 and FIGS. 2 and 3. Table 3 presents the mean(±SD) creatinine adjusted porphyrin concentrations by sex for all nonchelated NT and AUT subjects. Values were stratified by 2-year age groups between 2 and 12 years of age. FIGS. 2 and 3 show the variation in these porphyrin levels by age for males only.

Average concentrations of most porphyrins were elevated in 2 NT male subjects <2 years of age compared with older NT males (Table 3). No AUT children <2 years of age were included in the study. Among males in the 2- to 12-year age groups, the mean concentrations of hexacarboxyl-porphyrin (p<0.01), pentacarboxyl-porphyrin (p<0.001), and coproporphyrin (p<0.009) were significantly higher among AUT compared with NT groups based on ANOVA F-test values, whereas the heptacarboxyl porphyrin was more of borderline significance (p<0.06). Uro- and precoproporphyrins did not differ significantly between AUT and NT groups.

FIGS. 2A-F illustrate the distributions of urinary porphyrins in male subjects by age and NT/AUT status. Substantial variation was observed in creatinine-normalized urinary porphyrin levels among AUT males. Additionally, decreasing concentrations of heptacarboxyl-, hexacarboxyl-, pentacarboxyl-, and coproporphyrins were observed with increasing age among NT males. The graphs in FIG. 2 depict substantial excess and variable excretion of most porphyrins among AUT compared with NT. The numbers of AUT and NT male subjects by for each age group are listed in Table 3. FIGS. 3A-F illustrate the associations between urinary porphyrins and age. Scatterplots with simple linear regression fit lines show inverse associations between age and porphyrins among NT males while also demonstrating that this pattern is disrupted among those with AUT (FIG. 3).

Urinary porphyrins and risk of autism. Logistic regression models of age-adjusted associations between porphyrin levels and AUT, AUT plus PDD-NOS, and PDD-NOS alone (all vs. NT) in males indicated significant associations of hexacarboxyl-, pentacarboxyl-, and coproporphyrins with AUT (Table 4). A one-unit increase in the natural log of the creatinine-adjusted value for coproporphyrin is associated with a 2-fold risk for AUT (OR=2.03; 95% CI, 1.15-3.57). Similar associations were observed with pentacarboxyl porphyrin (OR=2.36; 95% CI, 1.3-4.07) and with hexacarboxyl-, pentacarboxyl-, and coproporphyrins combined (OR=2.38; 95% CI, 1.42-3.97). In contrast, porphyrin levels did not differ between PDD-NOS and NT males in this study; consequently, combining PDD-NOS and AUT subjects weakened associations. Thus, this analysis seems to indicate that AUT is a distinct entity from PDD-NOS in terms of being associated with altered porphyrin excretion. Alternatively, too few PDD-NOS subjects were available to this exploratory study to demonstrate an association with PDD-NOS as a less markedly affected portion of the autistic spectrum. Further studies involving greater numbers of subjects with PDD-NOS as well as other recognized disorders of the autistic spectrum would assist in determining the extent to which the strength of the association varies with the degree of ASD. Surprisingly, urinary Hg and other Hg-related measures were not significantly associated with AUT based on logistic models with and without adjustment for porphyrins (data not shown).

Discussion:

Urinary porphyrins are naturally elevated in young children. The mean urinary porphyrin concentrations are described for children in the age range of 2-12 years who participated in the present study. Of particular note is the observation that younger children have inherently higher porphyrin concentrations, particularly of uro-, heptacarboxyl-, and coproporphyrins, which decline by as much as 2.5 times over the 2-12-year age range. Also of interest is the finding that precoproporphyrin, an atypical porphyrin previously identified only in adult humans and animals with prolonged exposure to Hg or Hg compounds, is present in substantial concentrations in urine of younger children. This is a novel and unexpected finding in light of previous observations from studies in animals (Woods et al. 1991) showing that precoproporphyrin is formed as a consequence of Hg inhibition of uroporphyrinogen decarboxylase in the kidney during prolonged exposure, producing excess pentacarboxylporphyrinogen, which then competes with coproporphyrinogen as a substrate for coproporphyrinogen oxidase as the basis of precoproporphyrin formation (Woods, J. S., et al., The Association Between Genetic Polymorphisms of Coproporphyrinogen Oxidase and an Atypical Porphyrinogenic Response to Mercury Exposure in Humans,” Toxicology and Applied Pharmacology 206:113-420, 2005). The etiology of this atypical porphyrin in the urine of young children in the presumed absence of prolonged Hg exposure as observed here remains unknown. One possible explanation may be the consequence of accelerated hepatic heme biosynthesis that occurs during the period of perinatal development (Woods, J. S., “Developmental Aspects of Hepatic Heine Biosynthetic Capability and Hematotoxicity,” Biochemical Pharmacology 25:2147-2152, 1976). In this respect, formation of precoproporphyrin would be consistent with the observation that the specific activity of hepatic uroporphyrinogen decarboxylase in perinatal rat liver greatly exceeds that of the adult (Woods, J. S., and Kardish, R. M., “Developmental Aspects of Hepatic Herne Biosynthetic Capability and Hematotoxicity. II. Studies on Uroporphyrinogen Decarboxylase,” Biochemical Pharmacology 32:73-78, 1983), likely generating comparably greater amounts of pentacarboxylporphyrinogen to compete with coproporphyrinogen as a substrate for coproporphyrinogen oxidase, as proposed in the etiology of precoproporphyrin in the presence of Hg exposure in adults (Woods et al., 2005). Further research is required to confirm this prospect.

Comparison of urinary porphyrins in NT and AUT children. The present results demonstrate that mean concentrations of uro- and precoproporphyrins are comparable between NT and AUT children of the same age ranges. In contrast, the concentrations of all remaining porphyrins, particularly hexacarboxyl-, pentacarboxyl-, and coproporphyrins, were significantly higher in AUT children than NT children, especially in older age groups. Additionally, heptacarboxyl-porphyrin is moderately associated with AUT compared to NT children. Several possibilities might account for these differences. Not to be bound by theory, Hg exposure appears unlikely to play a role in this effect, because no significant differences were observed between NT and AUT subjects for indices of past exposure to Hg from dental or medical sources, as reported by parents/caregivers. Additionally, urinary Hg concentrations, measures of recent Hg exposure, were very low among all subjects in this study (Table 2), and no significant differences between diagnostic groups were observed. As noted recently (Woods et al., “Urinary Porphyrin Excretion in Children With Mercury Amalgam Treatment: Findings From the Casa Pia Children's Dental Amalgam Trial,” Journal of Toxicology and Environmental Health 72:891-896, 2009a) incipient although statistically nonsignificant changes in urinary porphyrin concentrations were seen among children with urinary Hg concentrations derived from prolonged dental amalgam Hg exposure on the order of 3.2 μg/g creatinine. This is nearly 10 times the mean urinary Hg concentration observed among children in this study. Similar findings describing very low blood Hg levels and insignificant differences between NT and AUT children have recently been reported (Hertz-Picciotto I., et al., “Blood Mercury Concentration in Charge Study Children With and Without Autism,” Environmental Health Perspectives 118:161-166, 2010). These observations do not preclude a possible role of Hg exposure from sources not measured or validated in the present study, especially during the perinatal period, in the etiology of autism or related neurodevelopmental disorders in some children, particularly in relation to genetic variation that may predispose to increased risk of the neurotoxic effects of Hg as Hg⁰ as reported in adults (Echeverria, D., et al., “Chronic Low-Level Mercury Exposure, BDNF Polymorphism, and Associations With Memory, Attention and Motor Function,” Neurotoxicology and Teratology 27:781-796, 2005; Echeverria, D., et al., “The Association Between a Genetic Polymorphism of Coproporphyrinogen Oxidase, Dental Mercury Exposure, and Neurobehavioral Response in Humans,” Neurotoxicology and Teratology 28:39-48, 2006; Echeverria, D., et al., “The Association Between Serotonin Transporter Gene Promoter Polymorphism (5-Httlpr) and Elemental Mercury Exposure on Mood and Behavior in Humans,” Journal of Toxicology and Environmental Health 73:552-569, 2010; Heyer, N. J., et al., “Catechol-Omethyltransferase (COMT) Val158Met Functional Polymorphism, Dental Mercury Exposure, and Self-Reported Symptoms and Mood,” Journal of Toxicology and Environmental Health 72:599-609, 2009). Instead, the present findings indicate that porphyrin metabolism, particularly in preadolescent children, may be too disordered or differently regulated to permit detection of the Hg-mediated changes in urinary porphyrin excretion that are apparent in adult subjects. Further studies using a substantially larger population, such as the National Children's Study now in progress (The National Children's Study. <http://www.nationalchildrensstudy.gov/Pages/default.aspx> [retrieved Jun. 21, 20101), are required to resolve this question.

While not wishing to be bound by any particular theory, another factor that may account for the differences in urinary porphyrin levels between AUT and NT children is mitochondrial dysfunction, a disorder commonly associated with autism (Correia, C., et al., “Brief Report: High Frequency of Biochemical Markers for Mitochondrial Dysfunction in Autism: No Association With the Mitochondrial Aspartate/Glutamate Carrier SLC25A12 gene,” Journal of Autism and Developmental Disorders 36:1137-1140, 2006; Oliveira, G., et al., “Mitochondrial Dysfunction in Autism Spectrum Disorders: a Population-Based Study,” Developmental Medicine & Child Neurology 47:185-189, 2005; Pons, R., et al., “Mitochondrial DNA Abnormalities and Autistic Spectrum Disorders,” Journal of Pediatrics 144:81-85, 2004). Of particular interest in this respect is the prospect of deficient mitochondrial porphyrin uptake mediated by the recently identified mammalian mitochondrial porphyrin transporter Abcb6 (Krishnamurthy, P., et al., “Identification of a Mammalian Mitochondrial Porphyrin Transporter,” Nature 443:586-589, 2006). Abcb6, one of several identified ATP-binding cassette transporters, is located in the outer mitochondrial membrane and has a particularly high affinity for coproporphyrinogen III. Defects in Abcb6 gene expression or in Abcb6 activity could predispose to impaired mitochondrial porphyrin uptake, leading to cellular accumulation and aberrant porphyrin metabolism and excretion. Similarly, defects in the mitochondrial transmembrane domain, which mediates the binding of porphyrins with the Abcb6 transporter, could restrict normal porphyrin metabolism, contributing to the disordered porphyrin excretion observed (Krishnamurthy et al. 2006; Krishnanumhy, P., et al, “The Role of Transporters in Cellular Heme and Porphyrin Homeostasis,” Pharmacology & Therapeutics 114:345-358, 2007). Although the association of Abcb6 with autism has yet to be investigated, numerous validated missense mutations of the Abcb6 gene have been reported (“SNP linked to Gene AbCb6 (geneID:10058) Via Contig Annotation,” National Center for Biotechnology Information. <http://www.ncbi.nlm.nih.gov/projects/SNP/snp_ref.cgi?chooseRs=all&go=Go&locusId=10058> [retrieved Jun. 21, 2010]).

Additionally, although genetic susceptibility studies were not included as part of the present investigation, previous studies identified a polymorphism in the gene encoding coproporphyrinogen oxidase (CPDX, EC 1.3.3.3) (Li, T., and Woods, J. S., “Cloning, Expression, and Biochemical Properties of Cpox4, a Genetic Variant of Coproporphyrinogen Oxidase That Affects Susceptibility to Mercury Toxicity in Humans,” Toxicological Sciences 109:228-236, 2009; Woods et al. 2005) that may predispose to impaired heme biosynthesis and subsequent heme-dependent neurological functions (Chernova et al., 2006; Echeverria et al., 2006). Genotyping studies of 100 DNA samples from autistic children acquired through the University of Washington Autism Center revealed more than double the expected frequency of the homozygous variant of this polymorphism (CPDX4) (rs1131857). An intriguing notion rests on the possibility that mitochondrial respiratory chain disorder associated with CPDX4, which itself is linked to the mitochondrial inner membrane (Grandchamp, B., et al., “The Mitochondrial Localization of Coproporphyrinogen Iii Oxidase,” Biochemical Journal 176:97-102, 1978), could account for exaggerated porphyrin excretion as observed here among at least a subgroup of those with autism. Future studies involving a larger cohort of subjects are required to confirm these findings and to define the genetic and/or metabolic factors associated with altered porphyrin excretion in autism.

Principal strengths of this study include the availability of urine samples for porphyrin and Hg analyses from all study participants and the established capabilities for accurately measuring and interpreting these constituents in the context of this study. Notably, the urinary porphyrin levels reported herein among NT children ≧8 years of age are comparable with normative values recently described for children and adolescents of the same ages who were participants in a large clinical trial (Woods et al., 2009b), supporting the generalizability of these findings. The urinary Hg levels measured in this study were also comparable with those reported for a nationally representative sample of children 6-11 years of age acquired as part of the 2003-2004 U.S. National Health and Nutrition Examination Survey [geometric mean=0.245; 95% CI, 0.213-0.304) (“National Health and Nutrition Examination Survey,” © 2007 Centers for Disease Control and Prevention, <http://www.cde.gov/nchs/nhanes.htm> [retrieved Jun. 21, 2010]).

Conclusion:

The findings demonstrated herein show significant differences in urinary porphyrin levels between NT and AUT of the same or equivalent age, suggesting disordered porphyrin excretion as a metabolic characteristic among at least a subset of AUT subjects. The results were consistent across age groups with significant differences in porphyrin levels between the diagnostic groups. These results provide a context for better understanding and interpreting altered porphyrin excretion among children with AUT/ASD, and establish the utility of extracellular porphyrin levels as indicators of AUT/ASD.

### EXAMPLE 2

This Example describes the development of approaches to control for individual variations in porphyrin levels, and confirms that certain porphyrin levels are useful to predict the presence of autistic spectrum disorders.

Rationale:

Although porphyrins are consistently created as part of the heme biosynthetic process, porphyrin excretion may vary between individuals. Previous computational analyses (Heyer et al., 2006) showed that much of this variation is determined by the level of uroporphyrin (8-CP), the initial porphyrin, formed along the heme biosynthetic pathway (see FIG. 1). Uroporphyrin was observed not to be associated with autism in the recent study described in EXAMPLE 1. Therefore, the mechanisms that create the association between other porphyrins and autism must intervene further along the heme biosynthetic pathway. Thus, in the present study individual porphyrins, as well as their ratios with uroporphyrin, were tested to determine whether individual variation can be reduced while maintaining the porphyrin association with autism.

Methods:

Subjects in this study were male children, aged 2-12 years, who participated in a comparative investigation of urinary porphyrin excretion in relation to diagnostic status: autistic cases (n=59) or neurotypical controls (n=57). Methods of subject recruitment, diagnostic and validation procedures, porphyrin analytical procedures, statistical data analysis, and human subjects' considerations are described in EXAMPLE 1.

The natural log of all three porphyrins concentrations that were strongly associated with autism (6-, 5-, and 4-carboxyl porphyrin concentrations) was evaluated as predictors of autism. Additionally, the natural logs of various combinations of sums of these porphyrins were evaluated as predictors of autism. Finally, the natural log of the ratios of these porphyrins, or sums of porphyrins, with uroporphyrin was evaluated as predictors of autism. The three measures that had the best sensitivity (percent of AUT cases correctly identified as cases) and specificity (percent of NT controls correctly identified as controls) are reported. The first measure is the natural log of 5-carboxyl porphyrin (referred to as the “penta” value). The two remaining measures are natural logs of ratios of a) 5-carboxyl porphyrin divided by uroporphyrin (referred to as “penta ratio” value) and b) the sum of 6-carboxyl, 5-carboxyl and coproporphyrin divided by uroporphyrin (referred to as the “combined ratio” value). While creatinine normalized values were used for all measures, this feature is immaterial for the ratio measures.

All analyses were conducted using the statistical package PASW statistics 18 (IBM® SPSS®, Chicago, Ill., USA). First, the assumption that the means of these measures did not significantly vary by two-year age groups among NT controls in the study population was tested using analysis of variance. Only the combined ratio came close to significance (p=0.058) among controls. None of these measures had significant differences in variance between age groups among controls.

Results:

The distributions of the three measures by case-control status are shown in Table 5. It is noted that actual measures being used in the analysis and reported in Table 5 are natural logs, where negative values represent an unlogged value between zero and one. To assist in interpretation of data presented in these tables, the unlogged values are show in brackets. It can be seen that in all cases, the mean value of each measure is greater among the AUT cases than among the NT controls.

TABLE 5
Descriptive statistics for porphyrin measures by case-control status

| | Case/ | | | | Std. |
|---|---|---|---|---|---|
| | Control | Minimum | Maximum | Mean | Deviation |
| Measure | N | [antilog] | [antilog] | [antilog] | [antilog] |
| Penta: | NT | −3.00 | 1.95 | 0.37 | 0.88 |
| Ln(μg Penta/ | 57 | [0.05] | [7.03] | [1.45] | [2.41] |
| g creatinine) | AU | −0.69 | 2.65 | 0.93 | 0.77 |
| | 59 | [0.50] | [14.15] | [2.53] | [2.16] |
| Penta Ratio: | NT | −0.52 | −0.14 | −1.71 | 0.82 |
| Ln(Penta/Uro) | 57 | [0.59] | [0.87] | [0.18] | [2.27] |
| | AU | −2.72 | 0.66 | −1.18 | 0.82 |
| | 59 | [0.07] | [1.93] | [0.31] | [2.27] |
| Combo Ratio: | NT | 0.89 | 4.00 | 2.13 | 0.66 |
| Ln((hexa + | 57 | [2.44] | [54.60] | [8.41] | [1.93] |
| penta + | AU | 1.25 | 4.14 | 2.52 | 0.76 |
| copro)/uro) | 59 | [3.49] | [62.80] | [12.43] | [2.14] |

NT = neurotypical control; AUT = autism case

Operating curves demonstrate the tradeoffs between sensitivity and one minus specificity (1−specificity). Sensitivity is the proportion of AUT cases that are correctly identified as cases (true positives), while 1−specificity is the proportion of NT controls that are incorrectly identified as AUT cases (false positives). As a test becomes more sensitive, it also identifies a greater number of false positives. Receiver Operating Characteristic (ROC) curves for porphyrin predictors of autism cases were generated for the natural log of pentacarboxyl porphyrin (designated as “Penta”), the natural log of the ratio of pentacarboxyl porphyrin to uroporphyrin (designated as “Penta Ratio”), and the natural log of the ratio of pentacarboxyl porphyrin plus hexacarboxyl porphyrin plus coproporphyrin to uroporphyrin (designated as “Combined Ratio”) (not shown). Table 6 provides the statistics related to the operating curves and shows that all three measures are highly significant.

TABLE 6
Area under the operating curve and statistical measures

| | | | | Asymptotic 95% | |
|---|---|---|---|---|---|
| | | | | Confidence Interval | |
| Porphyrin | | Std. | Asymptotic | Lower | Upper |
| Variable | Area | Error^{a} | Significance. | Bound | Bound |
| Penta | .670 | .050 | .002 | .573 | .767 |
| Penta Ratio | .672 | .050 | .001 | .574 | .770 |
| Combined Ratio | .639 | .051 | .010 | .539 | .739 |

From these operating curves, it is apparent that the three measures vary between that providing the greatest sensitivity for any given “1−specificity”. In this respect, the penta ratio identifies the greatest number of true AUT cases (7 or 12%) before identifying any false (NT) positives. The combined ratio identifies 11 cases (18.6%) with only one false positive, whereas the penta measure identifies 16 AUT cases (27.1%) with only two false positives. The preferred measure among these three will depend upon the circumstance in which it was being used.

Discussion:

As demonstrated in EXAMPLE 1, mean urinary porphyrin concentrations are inherently high in young children compared with those in adults and decline by as much as 2.5 times between ages 2 and 12 years. Coproporphyrin and heptacarboxyl-, hexacarboxyl-, and pentacarboxyl-porphyrins were generally elevated among autistic children compared with NT children of the same age. Surprisingly, elevated porphyrin levels among AUT children were not associated with measures of past or current Hg exposure, and a porphyrin pattern consistent with that seen in adults with prolonged Hg exposure was not apparent. These findings suggest that disordered porphyrin metabolism may be a salient characteristic of autism and encourage further investigation of genetic, metabolic, and/or environmental factors that may explain this association. Additionally, these findings demonstrate the utility of extracellular porphyrin levels as a useful biomarker for a subset of autistic spectrum disorder. It is demonstrated here that the wide variation in porphyrin levels observed in individuals can be reduced by normalizing the values with uroporphyrin concentrations, with correlations to the presence of autism in the subject. Specifically, the natural log of 5-carboxyl-porphyrin value, the natural log of the 5-carboxyl-porphyrin to uroporphyrin value, and the natural log of the sum of 6-, 5-, and 4-carboxyl porphyrin, divided by the uroporphyrin value, exhibited the best sensitivity and specificity with significant correlations with the presence of autism in the subject.

Conclusion:

This example demonstrates the successful use of urinary porphyrin levels and analytic approaches to successfully differentiate autistic from neurotypical children across several age categories. This establishes the utility of this approach as a non-intrusive, rapid, relatively inexpensive, and readily available biological test, which has very favorable predictive characteristics compared with more complex genetic and placental abnormality screens described in recent literature. Autism is generally accepted to be a multi-factorial disease with diverse etiologies. As such, the porphyrin tests described in this example are powerful predictors for a subset of autism presence and risk, and help define specific genetic and/or metabolic defects associated with this disorder.

### EXAMPLE 3

This example demonstrates an expanded assessment of pentacarboxyl- and coproporphyrin as biomarkers for autism and Pervasive Developmental Disorder-Not Otherwise Specified (PDD-NOS), and confirms the strong correlation of the porphyrins with these aspects of autistic spectrum disorder.

Rationale:

Autism (AUT) is a complex neurodevelopmental disorder that, together with Asperger Syndrome and Pervasive Developmental Disorder-Not Otherwise Specified (PDD-NOS), comprises the expanded classification of autistic spectrum disorder (ASD). The complexity of ASD and other pervasive developmental disorders, the multi-factorial nature of these disorders, and the difficulty in diagnosing and distinguishing between these at early ages have led many health care providers to view autism as a spectrum disorder. The heterogeneity of ASD also underlies the need to identify biomarkers or clinical features that can be employed to identify meaningful subtypes of ASD, define specific etiologies, and inform intervention and treatment options.

As described in EXAMPLES 1 and 2, the inventors have shown that disordered porphyrin metabolism, manifested principally as significantly elevated urinary concentrations of pentacarboxyl-(penta) and coproporphyrins, is commonly observed among some children with ASD independent of heavy metal exposure. Briefly, a study was conducted of male children aged 2-12 years with validated AUT or PDD-NOS diagnoses and age-matched neurotypical (NT) controls (Woods et al., 2010). The findings demonstrated significantly elevated concentrations of hexa-carboxyl porphyrin (OR=1.65[1.07-2.551), pentacarboxyl porphyrin (OR=2.36[1.37-4.071), and coproporphyrin (OR=2.03[1.15-3.571) among children with ASD when compared with those of age-matched neurotypical (NT) controls. These findings suggested that porphyrin metabolism may be disordered or impaired among some ASD children and, significantly, that porphyrin measures have clinical utility as a biomarker for ASD identification and/or classification independent of heavy metal exposure.

In this example, these observations are extended by specifically evaluating urinary concentrations of pentacarboxyl- and coproporphyrins, referred to hereafter as “penta” and “copro”, as predictive biomarkers of risk for AUT and PDD-NOS among 76 male children comprising 30 with validated AUT, 14 with PDD-NOS and 32 neurotypical (NT) controls. Specifically, graphical and statistical analyses were employed to evaluate the distribution of urinary concentrations of these porphyrins by diagnosis, and to determine the predictive (sensitivity and specificity) values of these measures for ASD detection. In this example, autism as AUT and PDD-NOS are referred to as separate diagnoses, with the understanding that the lines between these may be blurred at times and that the latter is frequently included within the collective designation of ASD.

Methods:

The study population. Subjects in this study were derived from the cohort of 118 male children, aged 2-12 years, with diagnosis of AUT, PDD-NOS, or NT who participated in the investigation of altered urinary porphyrin excretion in relation to mercury exposure in children with AUT described above in EXAMPLES 1 and 2. All subjects were recruited from among families residing within the Pacific Northwest metropolitan areas of Seattle and Spokane, Wash., and Portland, Oreg., and whose diagnoses had been performed by established autism diagnostic and treatment centers including the University of Washington Autism Center, the Seattle Children's Autism Center, the Oregon Health and Sciences University, and the Kaiser Permanente Developmental Assessment Clinic. Subjects were selected from among children for whom behavioral intervention was the principal therapeutic approach and who, therefore, had not received treatment with potentially porphyrinogenic drugs such as mood stabilizers or anti-depressants, e.g., valproic acid (depakote, convulex) or risperidine (risperdal). Subjects were also assessed prior use of chelating agents, which might also alter porphyrin excretion, and excluded from the analysis those reporting a prior history of chelation therapy (n=42). Thus, the final study cohort of 76 eligible children included 30 diagnosed with AUT, 14 as having PDD-NOS, and 32 NT controls. It is noted that this study cohort is a subset of the population studied in Examples 1 and 2.

Diagnostic procedures. The diagnosis of AUT or PDD-NOS was made using a multidisciplinary approach that combined a clinical evaluation using the Diagnostic and Statistical Manual of Mental Disorders, 4^{th} Edition, Text Revision (DSM-IV-TR) (American Psychiatric Association, 2000) criteria, along with a psychological evaluation using the Autism Diagnostic Observation Schedule (ADOS) (Lord et al., 2000), supplemented by other established diagnostic procedures such as the Autism Diagnostic Interview-Revised (ADI-R) (Rutter, M., et al., “ADI-R: Autism Diagnostic Interview-Revised,” Los Angeles, Calif.: Western Psychological Services, 2003) or the Childhood Autism Rating Scale (CARS) (Schopler et al., 1988). More than 90% of subjects were diagnosed since 2003, supporting continuity and homogeneity in the methods and procedures employed in the diagnoses.

Human subjects considerations. The study protocol was approved by the institutional review board at the University of Washington. All parents/caregivers gave written consent for themselves and their children prior to enrollment in the study.

Urinary porphyrin and creatinine measurements. Urinary porphyrin concentrations were measured as previously described (Bowers et al., 1992; Woods et al., 1991) and were expressed as nanomoles per gram of creatinine (nmol/gCr). This well-established procedure employs high-performance liquid chromatography and spectrofluorometric detection to separate and quantify total concentrations of individual porphyrins. Urinary creatinine concentrations were measured using a standard colorimetric procedure (Sigma, St. Louis, Mo., USA). For statistical analyses, urinary porphyrin concentrations were first creatinine-adjusted (nanomoles per gram) and then transformed using the natural logarithm.

Statistical procedures. Variations of porphyrin concentrations by age among children younger than 8 years, whether NT or diagnosed with AUT or PDD-NOS, have not been well described. Therefore, both graphical and statistical analyses were conducted to fully evaluate the distributions of urinary porphyrin concentrations within this cohort. All analyses were conducted using the statistical package PASW statistics 18 (IBM® SPSS®, Chicago, Ill., USA).

Initial graphical analyses included scatter plots by diagnostic status (AUT, PDD-NOS and NT) against age for urinary concentrations of penta- and coproporphyrin, as well as for a combined score. Due to the large absolute differences in urinary concentrations of penta- and coproporphyrin, their Z-scores were calculated and added together to create a combined metric. These graphical plots allowed visual identification of subjects with values above the 95% confidence interval (CI) controlling for age. The graphical plots also facilitated identification of cutoff concentrations for potential biomarker-values, maximizing the number of cases identified (true positives) while simultaneously minimizing the number of controls (false positives) included. ROC curves were used to provide a graphical display of the various combinations for sensitivity and specificity of these biomarkers.

Results:

A description of the study population by diagnostic status is provided in Table 7. The study population was comprised of male children ranging in age from 2.5 to 12.4 years of age. There were no statistical differences in the means for age and creatinine concentrations between any of the groups. Pentacarboxyl porphyrin (p<0.02) and coproporphyrin (p<0.004) concentrations were significantly higher among AUT children compared to same-age NT controls, but not between PDD-NOS and controls. ASD children (defined as the combination of AUT and PDD-NOS) had higher mean urinary penta (p<0.006) and copro (p<0.006) concentrations compared to same-aged NT children, each characterized by a number of extreme values. As described in EXAMPLE 1, no association of altered porphyrin concentrations with any measure of lead, mercury, or other xenobiotic exposure were found (data not shown).

TABLE 7
Characteristics of Study Population (all Males)

| | | | Creatinine | Porphyrins (nmol/gCr) | |
|---|---|---|---|---|---|
| Case Status | Measure | Age | (g/l) | Penta | Copro |
| Control (NT) | Mean | 7.18 | 1.06 | 1.21 | 56.44 |
| (N = 32) | Range | 2.3-11.7 | 0.23-2.48 | 0.22-3.70 | 10.1-126.4 |
| | Std. Dev. | (3.02) | (0.46) | (0.65) | (32.42) |
| Autistic | Mean (p-value)* | 6.08 (.09) | 0.96 (.36) | 1.95 (.02) | 89.01 (.004) |
| (N = 30) | Range | 3.2-11.3 | 0.44-1.80 | 0.50-7.43 | 18.5-199.6 |
| | Std. Dev. | (1.96) | (0.39) | (1.49) | (49.48) |
| PDD-NOS | Mean (p-value)* | 6.59 (.51) | 0.96 (.48) | 1.86 (.13) | 66.36 (.32) |
| (N = 14) | Range | 2.5-12.4 | 0.44-1.92 | 0.39-5.91 | 16.1-121.5 |
| | Std. Dev. | (2.64) | (0.43) | (1.47) | (29.29) |
| Total | Mean | 6.64 | 1.00 | 1.62 | 71.12 |
| (N = 44) | Range | 2.3-12.4 | 0.23-2.48 | 0.22-7.43 | 10.1-199.6 |
| | Std. Dev. | (2.59) | (0.43) | (1.24) | (41.88) |

*equality of means compared to controls (t-test, equal variance not assumed)

FIG. 4 graphically shows the distribution of urinary porphyrin concentrations by age for pentacarboxyl porphyrin (FIG. 4A) and coproporphyrin (FIG. 4B) with regression-predicted levels and 95% Confidence Intervals (CI) for controls. The graphs clearly distinguish between AUT, PDD-NOS cases, and NT controls. In addition, FIGS. 4A and B show solid lines representing the simple regression of porphyrin concentrations with age and associated 95% CIs calculated only among NT controls in order to estimate normal distributions among children in this age range. For both graphs, it is clear that AUT and PDD-NOS cases dominate the highest porphyrin concentrations. Thus, two cutoff concentrations (shown by the horizontal dotted lines) were selected for each porphyrin. The higher cutoff excludes all NT controls, providing 100% specificity (32/32) (no false positives), whereas the lower cutoff allows for two false positive NT controls, providing 94% specificity (30/32).

Results for pentacarboxyl porphyrin are shown in FIG. 4A. The higher cutoff (3.2 nmol/gCr) identifies 5 AUT and 1 PDD-NOS cases, whereas the lower cutoff (2.1 nmol/gCr) identifies 9 AUT and 5 PDD-NOS cases. Notably, all identified cases are under 10 years of age (the oldest being 7.2 and 9.1 for AUT and PDD-NOS, respectively), whereas both the NT controls identified by this lower cutoff are over 10 (10.7 and 11.1). There are very few cases in this study over the age of 10, and it is possible that the specificity of this cutoff might be artificially reduced by the age range of this study. The upper 95% CI for the controls (age adjusted) falls midway between these two cutoff levels, and identifies 6 AUT and 4 PDD-NOS cases, along with one NT control.

Results for coproporphyrin are shown in FIG. 4B. Here the higher concentration cutoff (127 nmol/gCr) identifies 7 AUT and no PDD-NOS cases, whereas the lower cutoff (108 nmol/grCr) identifies 10 AUT and 2 PDD-NOS cases. The upper 95% CI closely parallels the higher cutoff concentration for this porphyrin and identifies 6 AUT cases and one NT control.

FIG. 5 graphically illustrates the distribution of Z-scores combined with age and with each other. FIG. 5A illustrates the distribution of combined score with age. FIG. 5B illustrates the variation of Z-scores with each other. The sum of Z-scores (measured in standard deviations or SD) for pentacarboxyl porphyrin and coproporphyrin concentrations were used to create a combined metric for these two porphyrins (FIG. 5). The combined Z-score has a range of −2.32 to 6.52 with a mean of 0.055 (SD=1.69). As can be seen in FIG. 5A, a cutoff of 1.13 SD identifies 10 AUT and 3 PDD-NOS cases with no NT controls.

Another interesting pattern is illustrated in FIG. 5B, where the two Z-scores are graphed against each other for the entire cohort. In order to better define the dominant underlying relationship (slope) between the two Z-scores, a simple regression with 95% CI was calculated twice to eliminate subjects outside of these limits, resulting in the elimination of 10 subjects. The third calculation, with 10 subjects eliminated, is shown superimposed on FIG. 5B (note that the two subjects just above the upper CI in FIG. 5B were not among the 10 eliminated). This final slope shows that pentacarboxyl porphyrin increases approximately 0.45 SD for each change of one SD for coproporphyrin, and appears to fairly represent the relationship between these porphyrins for the majority of subjects. This observation is consistent with the sequential formation of each porphyrin along the heme biosynthetic pathway (FIG. 1).

It is also clear from FIG. 5B that the 10 subjects eliminated from the calculation vary considerably from the calculated slope, and that these subjects are dominated by AUT and PDD-NOS cases. Among the 10 outliers were 4 AUT and 4 ASD cases, and only 2 NT controls. Variation from the dominant ratio between these two porphyrins may be another indicator of case status.

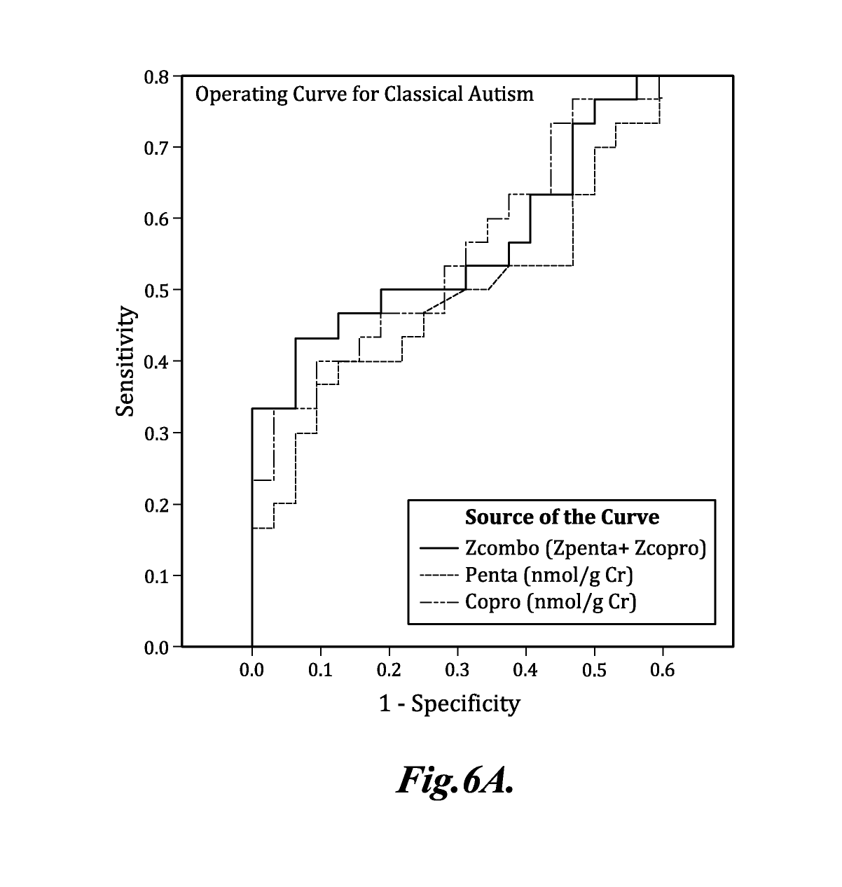

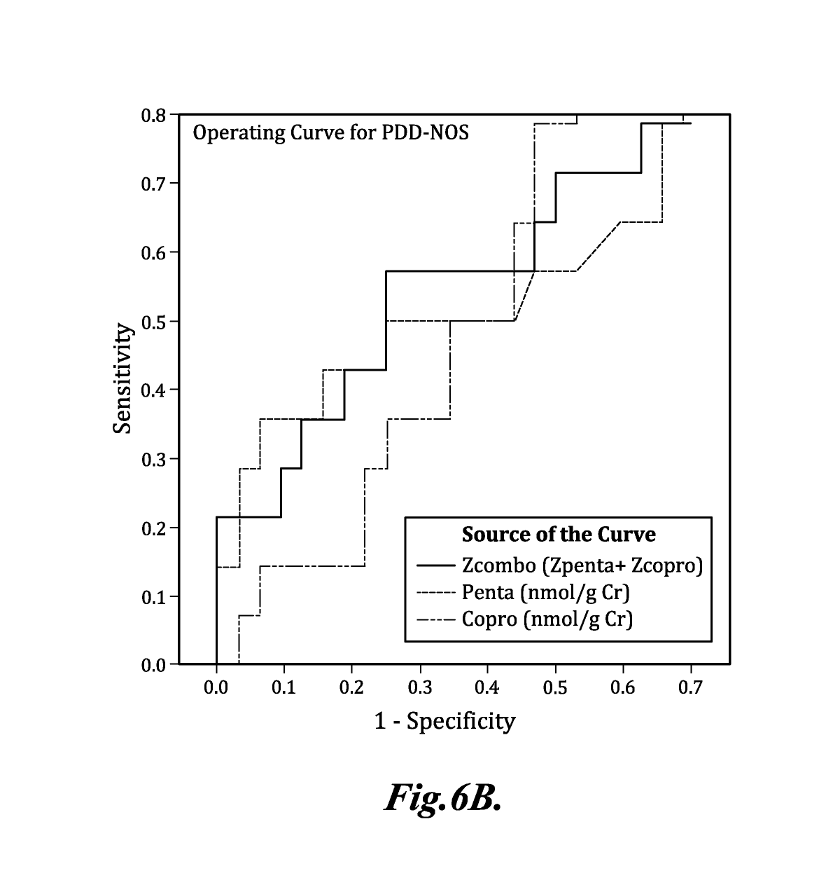

FIG. 6 graphically illustrates the operating curves for three porphyrin measures predicting Autism (FIG. 6A) and PDD-NOS (FIG. 6B). The ROC curves shown in FIG. 6 demonstrate the combinations of sensitivity (true positives) and [1 minus (1−)specificity] (false positives) for the three porphyrin measures described above. FIG. 6A demonstrates that, while the combined Z-scores and coproporphyrin measures appear to be the best predictors for AUT cases in terms of overall sensitivity, all three measures are within the same range. However, for PDD-NOS cases (FIG. 6B), combined Z-scores and pentacarboxyl porphyrin measures are the best predictors. Selected sensitivity and specificity calculations for the three porphyrin measures in detecting AUT and PDD-NOS cases, individually and combined, are presented in Table 8. The combined Z-score measure provides one of the best combinations of sensitivity and specificity, identifying 33% of ASD and 21% of PDD-NOS cases as true positives before identifying the first NT control (false positive) within the cohort of all 76 study subjects.

TABLE 8
Selected Sensitivity & Specificity for AUT, PDD-
NOS & Combined Cases for 3 Porphyrin Measures

| Test Criteria | Control | Autism | PDD-NOS | Combined | Case/Control |
|---|---|---|---|---|---|
| Penta Criteria: | Urinary Penta > 2.1 nmol/gCr | | | | |
| True Positive (Sensitivity) | | 9 (30%) | 5 (36%) | 14 (32%) | Cases |
| False Negative (1-Sensitivity) | | 21 (70%) | 9 (64%) | 30 (68%) | |
| True Negative (Specificity) | 30 (94%) | | | | Controls |
| False Positive (1-Specificity) | 2 (6%) | | | | |
| Total | 32 | 30 | 14 | 44 | |
| Copro Criteria: | Copro > 108 nmol/gCr | | | | |
| True Positive (Sensitivity) | | 10 (33%) | 2 (14%) | 7 (16%) | Cases |
| False Negative (1-Sensitivity) | | 20 (67%) | 12 (86%) | 37 (84%) | |
| True Negative (Specificity) | 30 (94%) | | | | Controls |
| False Positive (1-Specificity) | 2 (6%) | | | | |
| Total | 32 | 30 | 14 | 44 | |
| Z-Score Combined Criteria: | Z-Penta ± Z-Copro > 1.13 | | | | |
| True Positive (Sensitivity) | | 10 (33%) | 3 (21%) | 13 (30%) | Cases |
| False Negative (1-Sensitivity) | | 20 (67%) | 11 (79%) | 31 (70%) | |
| True Negative (Specificity) | 32 (100%) | | | | Controls |
| False Positive (1-Specificity) | 0 | | | | |
| Total | 32 | 30 | 14 | 44 | |

Discussion:

Autistic spectrum disorder (ASD) is generally accepted to be a multi-factorial biological disorder that is characterized by a broad spectrum of behavioral and clinical symptoms. This heterogeneity remains a major challenge in the diagnosis of ASD as well as to the selection of intervention and treatment options. Identification of biological markers that can be employed to identify categorical ASD subgroups is critical to reducing this heterogeneity, defining etiologies, and informing response to treatment. The present analyses demonstrate the utility of urinary porphyrin measurements as a specific biomarker for identifying a subgroup of ASD subjects in whom disordered porphyrin metabolism may be a salient characteristic. Whereas the present study reports a sensitivity of porphyrin measures of approximately 30% among all ASD children, the sensitivity of these measures might, in fact, be much higher, possibly approaching 100%, for a specific subset of ASD subjects in whom disordered porphyrin metabolism may be associated with a specific neurological phenotype. In this respect, this non-intrusive, rapid, relatively inexpensive, and readily available clinical test has very favorable predictive characteristics compared with more complex genetic and placental abnormality screens described in recent literature.

The specific mechanistic association of elevated urinary porphyrin concentrations with an autistic neurobehavioral phenotype that defines a specific ASD category remains to be delineated. However, heme is known to play a critical role as a signaling molecule in glutaminergic neuronal receptor processing and synapse development (Sengupta et al. 2005; Chernova et al. 2006), as well as in the regulation of serotonin (5-hydroxytryptamine) synthesis and signaling in the central nervous system (Litman, D. D., and Correa, M. A., “L-Tryptophan: A Common Denominator of Biochemical and Neurological Events of Acute Hepatic Porphyria?” Science 222:1031-1033, 1983; Litman, D. D., and Correa, M. A., “Elevated Brain Tryptophan and Enhanced 5-Hydroxytryptamine Turnover in Acute Hepatic Heme Deficiency: Clinical Implications,” Journal of Pharmacology and Experimental Therapeutics 232:337-345, 1985). Disorders of both systems have been implicated as etiological factors in autism (Anderson, B. M., et al., “Examination of association of genes in the serotonin system to autism,” Neurogenetics 10:209-216, 2009; Bill, B. R., and Geschwind, D. H., “Genetic Advances in Autism: Heterogeneity and Convergence on Shared Pathways,” Current Opinion in Genetic Development 19:271-278, 2009). In terms of glutaminergic signaling, heme has been identified as a regulatory factor in the formation and heteromeric assembly of N-methyl-D-aspartate (NMDA) receptor subunits NR1 and NR2 (Chernova, T., et al., “Neurite Degeneration Induced by Heme Deficiency Mediated Via Inhibition of NMDA Receptor-Dependent Extracellular Signal-Regulated Kinase ½ Activation,” Journal of Neuroscience 27:8475-8485, 2007; Chernova, T., et al., “Early Failure of N-methyl-D-aspartate Receptors and Deficient Spine Formation Induced by Reduction of Regulatory Heme in Neurons,” Molecular Pharmacology 79:844-54, 2011), both of which are constituents of putative convergent biological pathways comprising the core ASD phenotype (Bill and Geschwind 2009; Wall, D. P., et al., “Comparative Analysis of Neurological Disorders Focuses Genome-Wide Search for Autism Genes,” Genomics 93:120-129, 2009). In the serotonin system, heme regulates the activity of tryptophan 2,3-dioxygenase (TDO2), the rate-limiting enzyme in the catabolism of tryptophan, the immediate precursor of serotonin. Defects in serotonin metabolism as well as abnormalities in circulating and brain serotonin levels have been reported in a wide variety of human behavioral and psychiatric disorders including autism (Chugani, D. C., et al., “Developmental Changes in Brain Serotonin Synthesis Capacity in Autistic and Nonautistic Children,” Annals of Neurology 45:287-295, 1999; Cook, E. H., Jr., and Leventhal, B. L., “The Serotonin System in Autism,” Current Opinion in Pediatrics 8:348-354, 1996; Leboyer, et al., “Whole Blood Serotonin and Plasma Beta-Endorphin in Autistic Probands and Their First-Degree Relatives,” Biological Psychiatry 45:158-163, 1999). Notably, hyperserotonemia has been consistently reported among approximately one third of autistic children (Cook and Leventhal 1996; Owley, T., et al., “Childhood Disorders: The Autism Spectrum Disorders,” in Tasman, A., et al., (eds.) Psychiatry, 2^{nd} edition, Chichester: Wiley, pp. 757-770), comparable to the proportion of ASD children identified as having significantly elevated porphyrin measures in the present study. While not bound by any particular theory, these observations provide a scientific rationale for a mechanistic association wherein disruption of heme biosynthesis, as manifested by aberrant porphyrin excretion, might underlie a pathology associated with a specific autistic neurologic phenotype. Additional studies are needed to further identify the associations of elevated porphyrin concentrations and the mechanistic link(s) defining a specific behavioral subset of ASD.

The present findings suggest a potentially important new approach toward categorizing ASD that can serve to improve identification and inform treatment of affected children. Future studies covering larger populations of NT and ASD subjects would serve to improve categorization of ASD, including enhanced differentiation between subset classifications and underlying etiologies. Furthermore, future studies would be well-served to include at least a second control population comprised of developmentally delayed children without ASD. This would permit further evaluation of disordered porphyrin measures in other neurodevelopmental disorders that do not have ASD as a clinical feature. Such further studies in a larger cohort that includes both ASD and other control groups will aim to define aberrant porphyrin excretion among ASD children in terms of quantitative differences in communication and social and repetitive behavior characteristics that comprise a circumscribed ASD core phenotype, and to identify genetic and mechanistic factors that may underlie this association.

Conclusion:

This example further demonstrates the utility of urinary pentacarboxyl porphyrin and coproporphyrin levels as biomarkers for a subset of autistic spectrum disorders manifesting in autism or PPD-NOS. Whether used independently or in combination, these porphyrins demonstrate strong sensitivity in identifying autistic and PPD-NOS in children. This establishes these porphyrin biomarkers as the basis for convenient, non-intrusive, rapid, and relatively inexpensive clinical tests with strong predictive power for a subset autistic spectrum disorders.

While illustrative embodiments have been described, it will be appreciated that various changes can be made therein without departing from the spirit and scope of the invention. Specific elements of any of the foregoing embodiments can be combined or substituted for elements in other embodiments. Furthermore, while advantages associated with certain embodiments of the disclosure have been described, other embodiments may also exhibit such advantages, and not all embodiments need necessarily exhibit such advantages to fall within the scope of the disclosure.

The embodiments of the invention in which an exclusive property or privilege is claimed are defined as follows:

1. A method of screening a human subject for the presence of, or risk of developing, an autistic spectrum disorder (ASD), comprising:
(a) determining an amount of at least one porphyrin from a set of porphyrin biomarkers for ASD in a biological sample obtained from the subject;
(b) comparing the amount of the at least one porphyrin determined in step (a) to a reference standard or threshold value; and
(c) determining the presence of, or risk of developing, an autistic spectrum disorder in the subject, wherein an elevated amount of the at least one porphyrin compared to the reference standard or threshold value is indicative of the presence of, or increased risk of developing, an autistic spectrum disorder in the subject.

2. The method of claim 1, wherein the set of porphyrin biomarkers for ASD comprises 4-carboxyl porphyrin, 5-carboxyl porphyrin, 6-carboxyl porphyrin, and 7-carboxyl porphyrin.

3. The method of claim 1, wherein step (a) comprises determining the amount of 5-carboxyl porphyrin in the biological sample.

4. The method of claim 1, wherein step (a) comprises determining the amount of 4-carboxyl porphyrin in the biological sample.

5. The method of claim 1, wherein step (a) comprises determining the amount of at least two porphyrins from the set of porphyrin biomarkers for ASD in the biological sample.

6. The method of claim 5, wherein step (a) comprises determining the amount of 4-carboxyl porphyrin and the amount of 5-carboxyl porphyrin in the biological sample.

7. The method of claim 1, wherein step (a) comprises determining the amount of at least three porphyrins from the set of porphyrin biomarkers for ASD in the biological sample.

8. The method of claim 1, wherein determining the amount of the at least one porphyrin in step (a) comprises performing an assay to determine the concentration of the at least one porphyrin in the biological sample.

9. The method of claim 8, wherein the assay is selected from the group consisting of a liquid chromatographic assay, a spectrofluorometric assay and an immunoassay.

10. The method of claim 1, wherein determining the amount of the at least one porphyrin in step (a) comprises normalizing the concentration for creatinine in the biological sample.

11. The method of claim 10, wherein the concentration of 5-carboxyl porphyrin in the biological sample is normalized for creatinine.

12. The method of claim 11, wherein a determination of at least about 2 nmol 5-carboxyl porphyrin per gram of creatinine in the biological sample obtained from the subject is indicative of the presence or increased risk of developing an autistic spectrum disorder in the subject.

13. The method of claim 10, wherein the concentration of 4-carboxyl porphyrin in the biological sample is normalized for creatinine.

14. The method of claim 10, wherein the concentrations of 5-carboxyl porphyrin and 4-carboxyl porphyrin in the biological sample are each normalized for creatinine and a combined statistical metric for the 5-carboxyl porphyrin and 4-carboxyl porphyrin in the biological sample is generated.

15. The method of claim 14, wherein the combined statistical metric is the sum of the individual Z-scores for the 5-carboxyl porphyrin and 4-carboxyl porphyrin in the biological sample.

16. The method of claim 1, wherein step (a) further comprises performing an assay to measure the concentration of 8-carboxyl porphyrin in the biological sample and normalizing the concentration of the at least one porphyrin from the set of porphyrin biomarkers determined in the biological sample for the amount of 8-carboxyl porphyrin measured in the biological sample.

17. The method of claim 1, wherein step (a) comprises determining the natural logarithm of the concentration of at least one porphyrin from the set of porphyrin biomarkers in the biological sample from the subject.

18. The method of claim 17, wherein a one unit increase in the natural logarithm concentration of 4-carboxyl porphyrin, 5-carboxyl porphyrin, or 6-carboxyl porphyrin, or a combination thereof, compared to the reference standard or threshold value is indicative of at least about 2-fold increase in the likelihood of the presence of, or risk of developing, an autistic spectrum disorder in the subject.

19. The method of claim 18, wherein a one unit increase in the natural logarithm concentration of at least 4-carboxyl porphyrin and 5-carboxyl porphyrin compared to the reference standard or threshold value is indicative of at least about 2-fold increase in the likelihood of the presence of, or risk of developing, an autistic spectrum disorder in the subject.

20. The method of claim 17, wherein step (a) comprises determining the natural logarithm of the sum of two or more concentrations of porphyrins selected from 6-carboxyl porphyrin, 5-carboxyl porphyrin and 4-carboxyl porphyrin.

21. The method of claim 1, wherein determining the amount of the at least one porphyrin in step (a) further comprises performing an assay to determine the concentration of 8-carboxyl porphyrin in the biological sample and calculating the natural logarithm of the ratio of the sum of two or more of the porphyrin concentrations to 8-carboxyl porphyrin concentration in the biological sample.

22. The method of claim 1, wherein the reference standard or threshold value is obtained from a control human subject or a population of control human subjects determined to be neurotypical.

23. The method of claim 22, wherein the control subject(s) is/are of an equivalent age to the human subject.

24. The method of claim 1, wherein the human subject is a young subject in the age range of from about 2 years to about 12 years old.

25. The method of claim 24, wherein the human subject is from about 2 years to about 5 years old.

26. The method of claim 1, wherein the biological sample is selected from the group consisting of urine, blood, serum, plasma and feces.

27. The method of claim 1, wherein the autistic spectrum disorder is at least one of autism or Pervasive Developmental Disorders Not Otherwise Specified (PDD-NOS).

28. The method of claim 1, wherein a subject with an elevated amount of the at least one porphyrin compared to the reference standard or threshold value is classified as a candidate for further testing and/or treatment.

29. The method of claim 1, further comprising determining the amount of the at least one porphyrin from the set of porphyrin biomarkers for ASD in a second biological sample obtained from the subject at a time subsequent to the time the biological sample in step (a) was obtained; and comparing the amount of the at least one porphyrin in the second biological sample to a second reference standard or threshold value; and determining the efficacy of a treatment therapy, wherein a lesser difference between the amount of the at least one porphyrin in the second biological sample and the second reference standard or threshold value, compared to the difference between the amount of the at least one porphyrin and the reference standard or threshold value determined in step (b) is indicative of a positive therapeutic effect of a treatment for ASD.

30. The method of claim 29, wherein the second biological sample is obtained from the human subject from about 2 months to about 2 years after the prior biological sample is obtained.

31. The method of claim 29, wherein the second reference standard or threshold value is obtained from a control human subject or a population of control human subjects determined to be neurotypical and is/are of an equivalent age as the human subject at the time the second biological sample is obtained.

32. The method of claim 1, wherein step (b) is performed by a suitably programmed computer.
